(19) United States
(12) Patent Application Publication
(10) Pub. No.: US 2002/0011475 A1
(43) Pub. Date: Jan. 31, 2002

(54) FIXING ROLLER MEMBER AND FIXING APPARATUS

(76) Inventors: SATOSHI HANEDA, TOKYO (JP); KUNIO SHIGETA, TOKYO (JP); YOTARO SATO, TOKYO (JP); HISAYOSHI NAGASE, TOKYO (JP)

Correspondence Address: BIERMAN MUSERLIAN AND LUCAS, 600 THIRD AVENUE, NEW YORK, NY, 10016

(21) Appl. No.: 09/309,233

(22) Filed: May 10, 1999

(30) Foreign Application Priority Data
May 12, 1998 (JP) 128924/1998
Jul. 10, 1998 (JP) 195593/1998

(51) Int. Cl. G03G 15/20

(52) U.S. Cl. 219/216; 219/469; 399/333; 399/330

(57) ABSTRACT

There is described a fixing apparatus, for fixing a toner image on a transfer medium by applying heat and pressure onto the transfer medium, which includes a heat ray irradiating device to irradiate heat rays and a pair of fixing rollers being hollow cylinders. The fixing roller includes a base body being a hollow cylinder and capable of transmitting the heat rays irradiated from the heat ray irradiating device, a heat-resistant resin layer formed on an outer surface of the base body and being capable of transmitting the heat rays irradiated from the heat ray irradiating device, and a heat ray absorptive layer provided on the heat-resistant resin layer.

### BACKGROUND OF THE INVENTION

The present invention relates to an image forming apparatus which incorporates a fixing apparatus to fix toner images formed on a transfer medium, such as a copier, a printer, a facsimile, or a similar apparatus, and particularly relates to a fixing roller member and a fixing apparatus being capable of instantaneous heating to perform quick start of a fixing operation.

Conventionally, as a fixing apparatus used for an image forming apparatus such as a copier, printer, or facsimile apparatus, a fixing apparatus of a thermal roller fixing system, which has a high degree of technological completion and is stable, is widely adopted in the apparatus from a low speed apparatus to a high speed one, and from a monochromatic apparatus to a full-color one.

However, in the fixing apparatus of the conventional thermal roller fixing system, when a transfer sheet or toner is heated, it is necessary to heat a fixing roller having large thermal capacity, accordingly, an energy saving effect is not good, thereby, it is disadvantageous for an energy saving aspect. Further, it takes a long period of time to warm up the fixing apparatus at printing, thereby, a long printing time period (warming-up time period) is necessary. Such problems have been observed with the conventional art.

In order to solve these problems, recently, such a fixing apparatus of a film fixing system is proposed and used, in which a sheet of film (thermal fixing film) is used, and the thickness of a thermal roller is made to an ultimate thickness of the thermal fixing film to decrease the thermal capacity; and a temperature-controlled heater (ceramic heater) is directly pressed on and brought into contact with the thermal fixing film, thereby, it is intended that efficiency of the thermal conductivity is greatly improved, resulting in energy saving and the quick start requiring almost no warming-up time period.

Further, such a fixing method in which a light transmissive base body is used for a fixing roller as a modification of the thermal roller; heat rays from a halogen lamp provided inside the base body are irradiated onto toner for thermal fixing, thereby, the quick start without a warming-up time period is intended, is disclosed in Japanese Tokkaishos No. 52-106741, No. 52-82240, No. 52-102736, No. 5-2102741, and the like. Alternatively, a fixing method is disclosed in Japanese Tokkaisho No. 59-65867 in which a fixing roller (a rotation member for heat ray fixing) is structured by providing a light absorption layer on the outer peripheral surface of the light transmissive base body; light beams from the halogen lamp provided inside a cylindrical light transmissive base body are absorbed by the light absorption layer provided on the outer peripheral surface of the light transmissive base body; and a toner image is fixed by the heat of the light absorption layer.

However, in the fixing apparatus using the thermal fixing film disclosed in above proposals, the energy saving and the quick start to decrease the warming-up time period are intended, but a fixing apparatus with a zero warming-up time period by application of instantaneous heating, can not be obtained, and further, stable running of the thermal fixing film can not be attained, and further, a shift of the toner image on the transfer sheet at fixing occurs due to deformation of the thermal fixing film in the fixing section, which are problems.

Particularly, in the method disclosed in Japanese Tokkaisho No. 52-106741, the light transmissive base body mainly formed of a glass pipe or polyimide resins is used as the base body of fixing roller, and specifically, the heat resistance, strength and light transmittance of the glass pipe are suitable, however, unevenness exists on the outer peripheral surface of the light transmissive base body, and accuracy of a degree of the true circle of the outer diameter is not so good, thereby, fixing becomes uneven, or wrinkles occur on the transfer material, which are problems. Further, toner easily adheres to the uneven portion or deformed portion, or filming easily occurs, and when toner adhesion or filming has occurred, only this portion is specifically easily heated, resulting in uneven fixing. Further, toner has a restriction due to the heat ray absorption property. That is, the light absorption property of the glass pipe base body is not so good for the color toner, and such the base body is hardly applicable for the color toner, which is disadvantageous.

Further, because the glass pipe is fragile and its processing ability is not so good, reverse-crown processing for wrinkle prevention, as processed for the conventional fixing roller using the metallic base body, is also difficult for the glass pipe base body, which is a problem.

### SUMMARY OF THE INVENTION

An object of the present invention is to solve the above-described problems and to provide a fixing roller member for quick start fixing in which instantaneous heating is realized or a heating time period is reduced by obtaining a light transmissive base body with a highly accurate outer diameter, and also to provide a fixing apparatus using heat rays for quick start fixing, in which uneven fixing or fixing wrinkles do not occur and instantaneous heating is realized or a heating time period is reduced.

To overcome the cited shortcomings, the abovementioned object of the present invention can be attained by an apparatus and/or a member described as follow:

(1) A fixing apparatus for fixing a toner image on a transfer medium by applying heat and pressure onto the transfer medium, comprising:

a heat ray irradiating device to irradiate heat rays; and

a pair of fixing rollers, being hollow cylinders, wherein at least one of the fixing rollers comprises

a base body being a hollow cylinder and capable of transmitting the heat rays irradiated from the heat ray irradiating device,

a heat-resistant resin layer formed on an outer surface of the base body and being capable of transmitting the heat rays irradiated from the heat ray irradiating device, and

a heat ray absorptive layer provided on the heat-resistant resin layer.

(2) A fixing roller for fixing a toner image on a transfer medium by applying heat and pressure onto the transfer medium, comprising:

a base body being a hollow cylinder and capable of transmitting heat rays;

a heat-resistant resin layer formed on the outer surface of the base body and being capable of transmitting the heat rays; and

a heat ray absorptive layer provided on the heat-resistant resin layer.

(3) An image forming apparatus, comprising:

toner image forming means for forming a toner image on a transfer medium; and

conveyance means for conveying the transfer medium, on which the toner image is formed, to a fixing means comprised of:

a heat ray irradiating device to irradiate heat rays; and

a pair of fixing rollers, being hollow cylinders, wherein at least one of the fixing rollers comprises

a base body being a hollow cylinder and capable of transmitting the heat rays irradiated from the heat ray irradiating device,

a heat-resistant resin layer formed on an outer surface of the base body and being capable of transmitting the heat rays irradiated from the heat ray irradiating device, and

a heat ray absorptive layer provided on the heat-resistant resin layer.

### BRIEF DESCRIPTION OF THE DRAWINGS

The objects and advantages of the present invention will become apparent upon reading the following detailed description and upon reference to the drawings in which:

FIG. 1 is a structural sectional view of a color image forming apparatus showing an example of an image forming apparatus for which a fixing apparatus of the present invention is used;

FIGS. 2(a), 2(b) and 2(c) are views showing a toner image forming condition in the image forming apparatus shown in FIG. 1;

FIG. 3 is a view showing an example of a document image reading means;

FIG. 4 is a block diagram of a control circuit of the image forming apparatus;

FIG. 5 is an illustration showing the structure of the first example of a fixing apparatus;

FIGS. 6(a) and 6(b) are enlarged structural sectional views of an upper side fixing roller member shown in FIG. 5;

FIG. 7 is a perspective view showing a condition of shaping of a light transmissive base body;

FIG. 8 is a view showing a density distribution of a heat ray absorption layer of the fixing roller member;

FIG. 9 is a view showing an outer diameter and thickness of the light transmissive base body of the fixing roller member;

FIG. 10 is an illustration showing an structure of the second example of the fixing apparatus;

FIGS. 11(a), 11(b) and 11(c) are enlarged structural sectional views of the upper side fixing roller member shown in FIG. 10;

FIG. 12 is an enlarged structural sectional view of a modified example of the upper side fixing roller member shown in FIG. 10;

FIG. 13 is a view showing the fixing apparatus for two-side fixing of the third example in which a pair of the fixing roller member for instantaneous fixing of the first example and the fixing roller member for instantaneous fixing of the second example is used;

FIG. 14 is a view showing the fixing apparatus for two-side fixing of the fourth example in which a pair of the fixing roller members for instantaneous fixing of the second example is used;

FIG. 15 is a temperature control timing chart at the time of two-sided image formation by using the fixing apparatus of the third example or the fourth example;

FIG. 16 is a temperature control timing chart at the time of one-side image formation of the obverse image by using the fixing apparatus of the third example or the fourth example;

FIG. 17 is a temperature control timing chart at the time of one-side image formation of the reverse side image by using the fixing apparatus of the third example or the fourth example;

FIG. 18 is a view showing the shape of the first example of the rotation member for heat ray fixing;

FIG. 19 is an enlarged structural sectional view taken on line A-A of the first example of the rotation member for heat ray fixing in FIG. 3;

FIG. 20 is a view showing a density distribution of the heat ray absorption layer of the rotation member for heat ray fixing;

FIG. 21 is a view showing an outer diameter and thickness of the light transmissive base body of the rotation member for heat ray fixing;

FIG. 22 is a view showing the shape of the second example of the rotation member for heat ray fixing;

FIG. 23 is an enlarged structural sectional view taken on line B-B of the second example of the rotation member for heat ray fixing in FIG. 22;

FIG. 24 is a structural sectional view of the rotation member for fixing, provided opposite to the rotation member for heat ray fixing of the first example in FIG. 18; and

FIG. 25 is a structural sectional view of the rotation member for fixing, provided opposite to the rotation member for heat ray fixing of the second example in FIG. 22.

### DETAILED DESCRIPTION OF THE PREFERRED EMBODIMENT

Examples of the present invention will be described below. Incidentally, description in these columns does not limit technological scope of claims and meanings of technological terms of the present invention. Conclusive description hereinafter in examples of the present invention show the best mode in each example, and does not limit the meanings of technological terms and the technological scope of the present invention. Hereinafter, in the description of examples, the surface of the transfer material opposite to the image forming body in the transfer area (upper surface) is defined as the obverse side, and the other surface of the transfer material, that is, the surface of the transfer material opposite to the intermediate transfer body (lower surface) is defined as the reverse side, and the image transferred onto the obverse side of the transfer material is defined as the obverse image, and the image transferred onto the reverse side is defined as the reverse image.

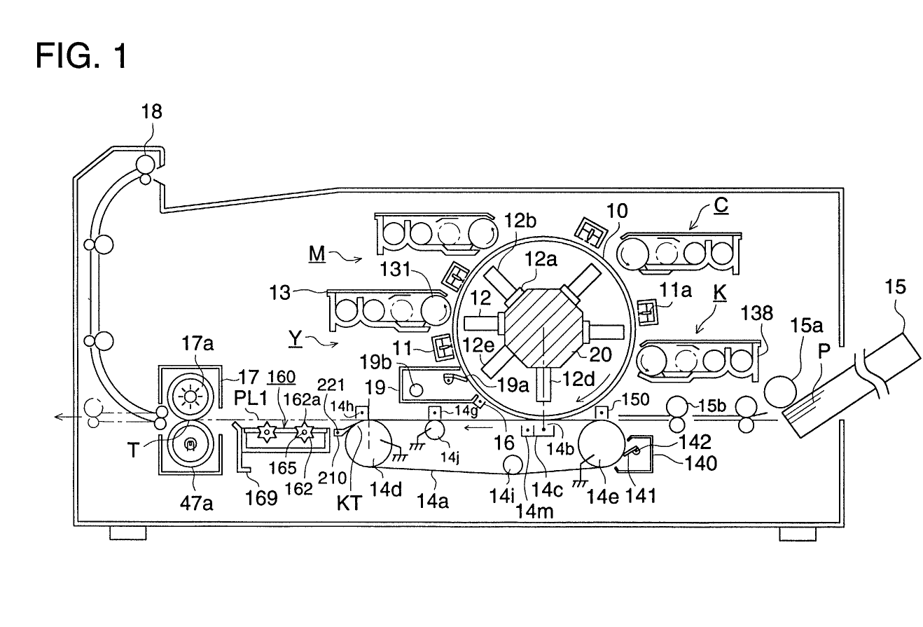

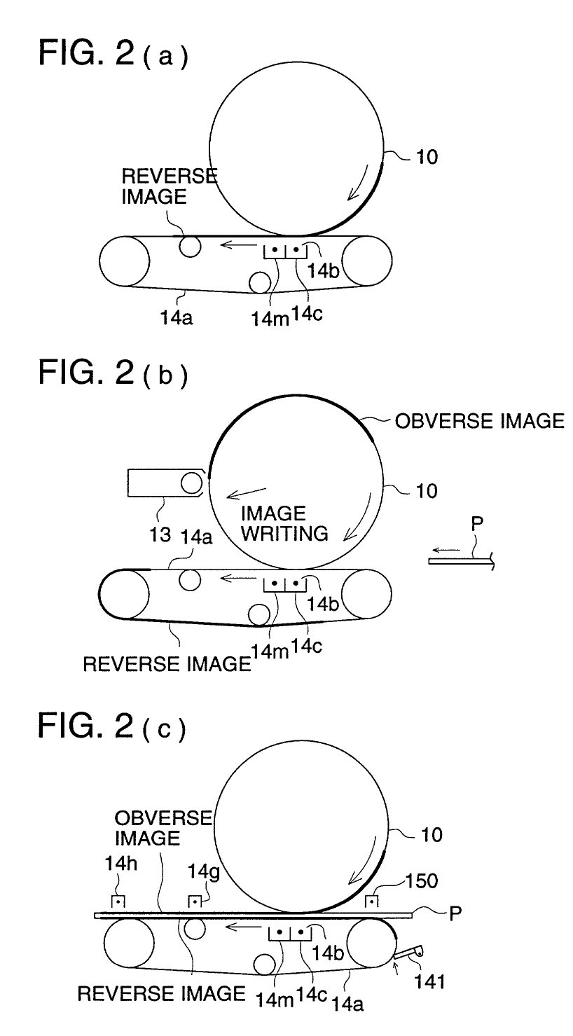

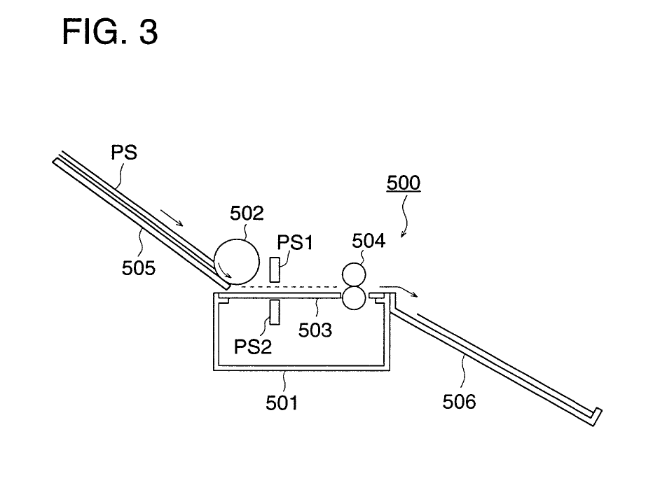

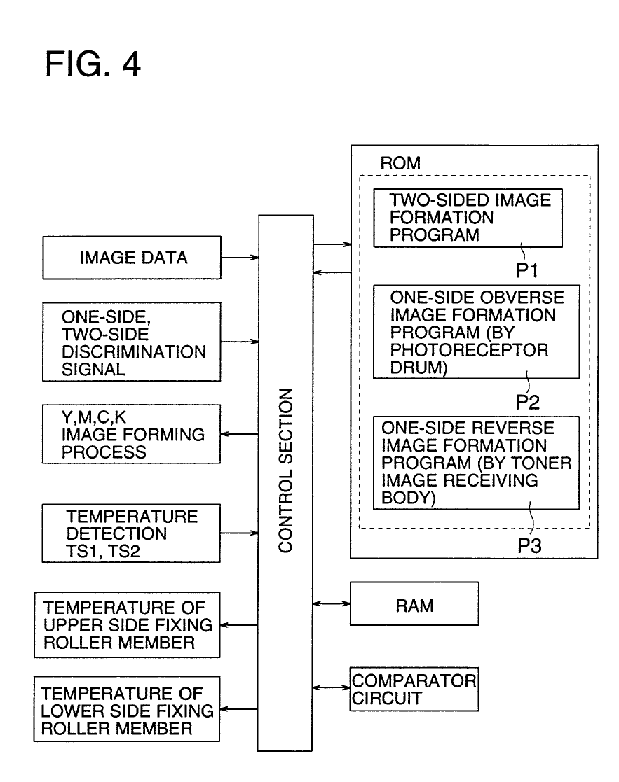

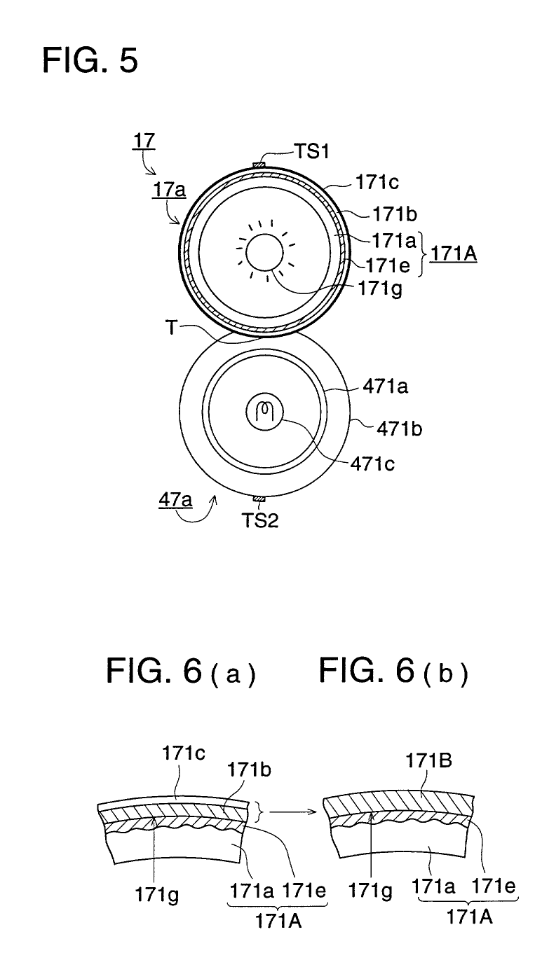

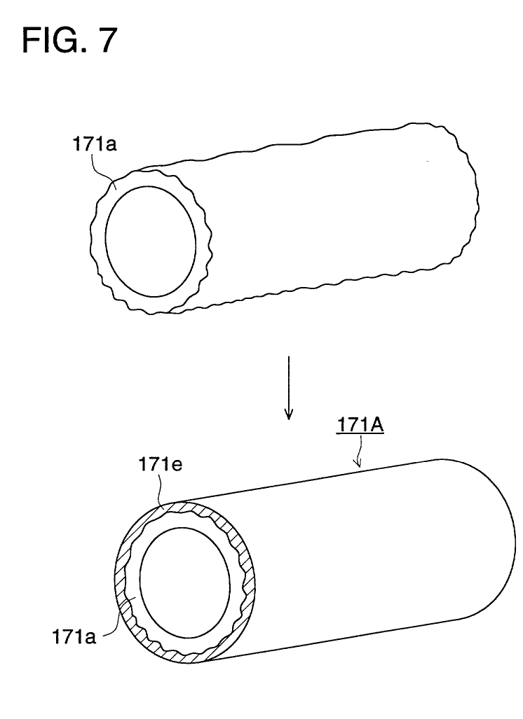

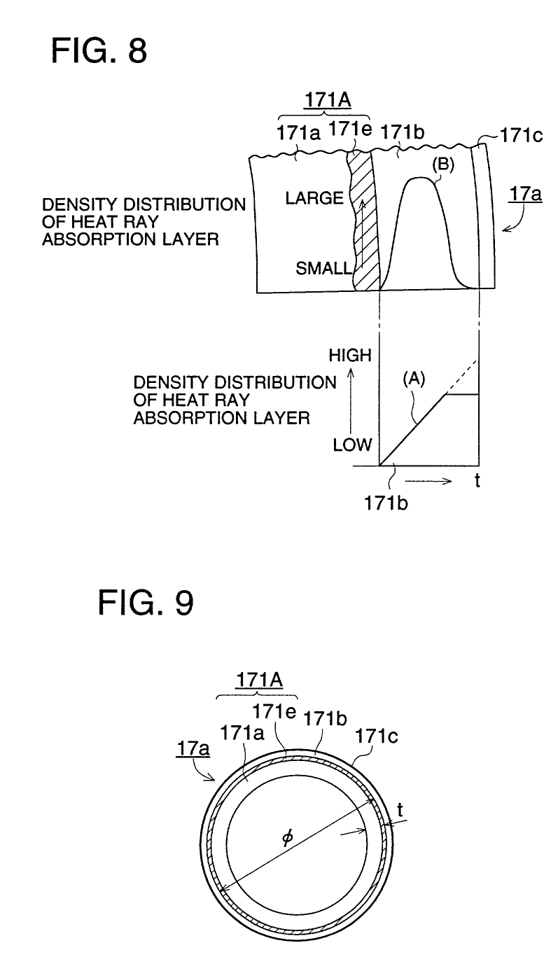

Referring to FIGS. 1 through 9, an image forming process and each mechanism of an example of an image forming apparatus used for a fixing apparatus according to the present invention will be described below. FIG. 1 is a structural sectional view of a color image forming apparatus showing an example of an image forming apparatus using a fixing apparatus according to the present invention, FIG. 2 is a view showing toner image forming conditions in the image forming apparatus in FIG. 1, FIG. 2(A) is a view showing a toner image forming condition when the reverse image formed on an image forming body is transferred onto an intermediate transfer body, FIG. 2(B) is a view showing a toner image forming condition when the obverse image is formed on the image forming body in timed relationship with the reverse image on the intermediate transfer body, FIG. 2(C) is a view showing the two-side image formation onto the transfer material, FIG. 3 is a view showing an example of a document image reading means, FIG. 4 is a block diagram of a control circuit of the image forming apparatus, FIG. 5 is an illustration showing a structure of the first example of the fixing apparatus, FIG. 6 is an enlarged structural sectional view of an upper side fixing roller member in FIG. 5, FIG. 7 is a perspective view showing the shaping of a light transmissive base body, FIG. 8 is a view showing a density distribution of a heat ray absorption layer of the fixing roller member, and FIG. 9 is a view showing an outer diameter and thickness of the light transmissive base body of the fixing roller member.

As shown in FIGS. 3 and 4, a document image reading apparatus 500 as a document image reading means is defined by a reading apparatus main body 501, a document accommodation tray 505 to accommodate a document PS, a document sensing roller 502, a transparent plate 503, a document conveying roller 504, a document delivery tray 506, and line-like document image reading sensors PS1 and PS2 having the transparent plate 503 between them, to read the document image of the document PS from above and below the document, and is connected to a control section via signal lines provided in outside apparatus or a color image forming apparatus to be described below.

When the document PS sent by the document sending roller 502 passes the transparent plate 503, the document is discriminated whether it is one-side document or two-sided document (discrimination of one-side document or two-sided one), and image data of the document PS is read by the document image reading sensors PS1 and PS2 provided above and below the transparent plate 503 which is nipped between the sensors.

In the present example, discrimination of one-side or two-side of the document and image data reading are conducted by one set of the upper and lower sensors, however, a plurality of sensors corresponding to respective image data reading and discrimination of one-side or two-side of the document may be provided. For example, by using a plurality of sensors respectively corresponding to these operations, image data reading may be conducted after the discrimination of one-side or two-side of the document is conducted. Image data of one set of documents PS are read by the document image reading sensor PS1 or PS2, and stored in a RAM through the control section.

According to the above, when the image is discriminated as the two-sided image, the image data of documents PS are read by the document image reading means shown in FIG. 3, and a two-sided image formation program P1 stored in a ROM shown in FIG. 4 is read into the RAM through the control section, the two-sided image formation program P1 is executed by the control section, and the image forming process is conducted.

In FIGS. 1 and 2, numeral 10 is a photoreceptor drum serving as an image forming body, numeral 11 is a scorotron charger serving as a charging means for each color, numeral 12 is an exposure optical system serving as an image writing means for each color, numeral 13 is a developing device serving as a developing means for each color, numeral 14a is an intermediate transfer belt serving as an intermediate transfer body, numeral 14c is a transfer device serving as the first and second transfer means, numeral 14g is a reverse side transfer device serving as the third transfer means, numeral 14m is a discharger serving as a discharging means, numeral 150 is a paper charger serving as a transfer material charging means, numeral 14h is a paper separation AC discharger serving as a transfer material separation means, numeral 160 is a conveyance section having a separation claw 210 serving as a claw member and a spur 162 serving as a spur member, numeral 169 is an entry guiding plate serving as an entry guiding member, and numeral 17 is a fixing apparatus of the first example.

The photoreceptor drum 10 serving as the image forming body has such a structure that, for example, a photoreceptor layer (also called photo-conductive layer) such as a transparent conductive layer, a-Si layer or organic photoreceptor layer (OPC), is formed on the outer periphery of a cylindrical base body formed of a transparent member such as optical glass or transparent acrylic resin, and is rotated clockwise as shown by an arrow in FIG. 1 while the conductive layer is electrically grounded.

The scorotron charger 11 serving as a charging means for each color, the exposure optical system 12 serving as an image writing means for each color, and the developing device 13 serving as a developing means 13 are combined into one set, and four sets of these means are provided for an image forming process for each color of yellow(Y), magenta (M), cyan (C) and black (k), and arranged in the order of Y, M, C, and K in the rotational direction of the photoreceptor drum 10 as shown by an arrow in FIG. 1.

The scorotron charger 11 serving as the charging means for each color has a control grid respectively kept at predetermined potential voltage, and a discharging electrode 11a formed of, for example, a saw-toothed electrode, and is provided opposing to the photoreceptor layer of the photoreceptor drum 10, and conducts a charging operation by corona discharging with the same polarity as that of toner (in the present example, negative charging), and applies uniform potential voltage onto the photoreceptor drum 10. As the discharging electrode 11a, a wire electrode or a needle-shaped electrode may also be applicable.

The exposure optical system 12 serving as the image writing means for each color is arranged inside the photoreceptor drum 10 in such a manner that the exposure position on the photoreceptor drum 10 is located at the downstream side in the rotational direction of the photoreceptor drum 10 with respect to the above-described scorotron charger 11 for each color. Each exposure optical system 12 is formed into an exposure unit structured by a linear exposure element 12a, in which a plurality of LEDs (light emitting diode) as a light emitting element for image-wise exposure light are aligned array-like, wherein the linear exposure element 12a is arranged in the primary scanning direction in parallel with a drum shaft; and a light converging optical transmitter (trade name: Selfoc lens array) 12b as an image forming element; and a lens holder, not shown, and the exposure unit is mounted onto a holding member 20. Other than the exposure optical system 12 for each color, a transfer simultaneous exposure unit 12d and a uniform exposure unit 12e are also mounted onto the holding member 20, and integrally accommodated inside a light transmissive base body of the photoreceptor drum 10. The exposure optical system 12 for each color imagewise-exposes the photoreceptor layer of the photoreceptor drum 10 from the reverse surface, according to image data for each color read by a separately provided image reading apparatus and stored in a memory, and forms an electrostatic latent image on the photoreceptor drum 10. As the exposure elements 12a, an exposure element in which a plurality of light emitting elements such as FLs (fluorescent material emission elements), ELs (electro-luminescence elements), PLs (plasma discharge elements), etc., are aligned array-like, may be used other than LEDs. The wavelength of light emission of the image-wise exposure light emitting element is used normally in the range of 780-900 nm within which the transparency of Y, M, C toners is high, however, in the present invention, because image-wise exposure is carried out from the rear surface of the photoreceptor drum, the shorter wavelength of 400-700 nm, which has insufficient transparency for color toners, may be allowable. Most of the image-wise exposure light is absorbed in the photoreceptor layer.

The developing devices 13, which are developing means for each color, have developing sleeves 131 formed of, for example, cylindrical non-magnetic stainless steel or aluminum material of 0.5-1 mm thickness, and of 15-25 mm outer diameter, developing sleeves being respectively rotated in the same direction as the photoreceptor drum 10 at the developing position, while keeping a predetermined gap with respect to the peripheral surface of the photoreceptor drum 10, and developing casings 138, in which one-component or two-component developers for yellow(Y), magenta (M), cyan (C), and black (K) are respectively accommodated. Each developing device has a predetermined gap of, for example, 100-500 μm with respect to the photoreceptor drum 10 with aid of a roller, not shown, and is kept in non-contact with the drum 10. When developing bias voltage in which DC voltage and AC voltage are superimposed, is applied onto the developing sleeve 131, non-contact reversal development is carried out and a toner image is formed on the photoreceptor drum 10.

An intermediate transfer belt 14a, which is an intermediate transfer body, is an endless belt having the volume resistivity of 10¹⁰-10¹⁶ Ω·cm, preferably 10¹²-10¹⁵ Ω·cm, and is a seamless belt having 2 layer construction consisting of 0.1-1.0 mm thick semi-conductive film base body on the outside of which 5-50 μm thick fluorine coating is preferably conducted as a toner filming prevention layer, wherein the semi-conductive film base body is formed by dispersing the conductive material in engineering plastics such as modified polyimide, thermo-hardened polyimide, ethylene tetra fluoroethylene copolymer, polyvinylidene fluoride, nylon alloy, etc. As a base body of the belt, in addition to the above, 0.5-2 mm thick semi-conductive rubber belt formed by dispersing conductive material in silicon rubber, or urethane rubber, may also be used. The intermediate transfer belt 14a is stretched by being respectively inscribed by a driving roller 14d, electrically grounding roller 14j, driven roller 14e, and tension roller 14i, which are roller members, and is rotated counterclockwise as shown by an arrow in FIG. 1. The driven roller 14e, electrically grounding roller 14j, driving roller 14d, and tension roller 14i, are provided in these order according to the rotational direction of the intermediate transfer belt 14a, and the driven roller 14e, electrically grounding roller 14j, driving roller 14d are rotated at these position, and the tension roller 14i is movably supported with aid of elastic force of a spring, not shown, or the like, and is rotated such that the intermediate transfer belt 14a is stretched. The driving roller is rotated by the drive of a driving motor, not shown, and drives the intermediate transfer belt 14a for rotation. The electrically grounding roller 14j, driven roller 14e, and tension roller 14i are driven by the rotation of the intermediate transfer belt 14a. The slack of the rotating intermediate transfer belt is strained by the tension roller 14i. The recording sheet P is separated from the intermediate transfer belt 14a at the curvature portion KT of the end portion of the intermediate transfer belt 14a stretched by the driving roller 14d, on the fixing apparatus 17 side.

The transfer device 14c, which is the first and second transfer means, is a corona discharger provided opposite to the photoreceptor drum 10 with the intermediate transfer belt 14a between them, and a transfer area 14b is formed between the intermediate transfer belt 14a and the photoreceptor belt 10. DC voltage having the polarity reverse to that of toner (in the present example, positive polarity) is applied onto the transfer device 14c, and a toner image on the photoreceptor drum 10 is transferred onto the intermediate transfer belt 14a or the obverse side of the recording sheet P, which is the transfer material.

The reverse side transfer device 14g, which is the third transfer means, is preferably structured by a corona discharger, and provided opposite to the conductive grounded roller 14j which is electrically grounded, with the intermediate transfer belt 14a between these members, and DC voltage having the polarity reverse to that of toner (in the present example, positive polarity) is applied onto the transfer device 14g, and a toner image on the intermediate transfer belt 14a is transferred onto the reverse side of the recording sheet P.

The discharger 14m, which is a discharging means, is preferably structured by a corona discharger, and is provided on the downstream side of the transfer device 14c in parallel to the transfer device 14c, which is the first and second transfer means, in the movement direction of the intermediate transfer belt 14a, and AC voltage on which DC voltage having the same polarity as or reverse polarity to that of toner is superimposed, is applied onto the discharger 14m, and the discharger 14m discharges electric charges on the intermediate transfer belt 14a which is charged when voltage is applied onto the transfer device 14c.

The paper charger 150, which is the transfer material charging means, is preferably structured by a corona discharger, and is provided opposite to the driven roller 14e with the intermediate transfer belt 14a between these means, and DC voltage with the same polarity as that of toner (in the present example, negative polarity) is applied onto the paper charger 150, and the recording sheet P is charged thereby and attracted onto the intermediate transfer belt 14a. As the paper charger 150, other than the corona discharger, a paper charging brush which can be brought into contact with and contact-released from the intermediate transfer belt 14a, or a paper charging roller may be used.

The paper separation AC discharger 14h, which is the transfer material separation means, is preferably structured by a corona discharger, and when necessary, it is provided opposite to the conductive driving roller 14d which is electrically grounded with the intermediate transfer belt 14a between these means, at the end portion of the intermediate transfer belt 14a on the fixing apparatus 17 side, and AC voltage on which DC voltage having the same polarity as pr reverse polarity to that of toner is superimposed, is applied onto the paper separation AC discharger 14 at need, and the recording sheet P conveyed by the intermediate transfer belt 14a is discharged and separated from the intermediate transfer belt 14a.

A conveyance section 160 has a separation claw 210, which is a claw member, and a spur 162, which is a spur member, and is provided between the curvature portion KT at the end portion of the intermediate transfer belt 14a on the fixing apparatus 17 side, and the fixing apparatus 17. The conveyance section 160 prevents the following disadvantages due to the heat from the fixing apparatus 17: the intermediate transfer belt 14a is deformed; the toner image carried on the intermediate transfer belt 14a is fused a little, thereby transferring becomes difficult; or toner fixedly adheres onto the intermediate transfer belt 14a.

The separation claw 210, which is a claw member, is in proximity to the curvature portion KT of the intermediate transfer belt 14a, and is fixedly provided on a support shaft 221 with a predetermined gap, preferably 0.1-2.0 mm gap, to the intermediate transfer belt 14a, and when the recording sheet P is separated from the intermediate transfer belt 14a, the leading edge portion of the recording sheet P which is going to be conveyed while being bent to the intermediate transfer belt 14a, is brought into contact with the separation claw 210, thereby the separation of the recording sheet P is helped.

The spur 162, which is the spur member, has a plurality of protrusions 162a on the peripheral surface, and is rotatably provided around a rotatable supporting shaft 163. The spur 162 guides the reverse side of the recording sheet P for conveyance, thereby, prevents the reverse side toner image of the recording sheet P having toner images on two-side thereof, from being disturbed, and stably conveys the recording sheet P to the fixing apparatus 17 while the entry direction of the recording sheet P to the fixing apparatus 17 is made constant.

The separation claw 210 and the spur 162 are provided in contact with or in proximity to the transfer material conveyance surface PL1, which is the surface PL1 connecting the curvature section KT of the intermediate transfer belt 14a with a transfer material inlet portion (entrance portion) to a nip portion T of the fixing apparatus 17, on the opposite side to the photoreceptor drum 10. The spurs 162, which are spur members, may be provided on both sides of the transfer material conveyance surface PL1.

An entry guiding plate 169, which is an entry guiding member, is provided in contact with or in proximity to the transfer material conveyance surface PL1, on the opposite side to the photoreceptor drum 10, and the top portion of the entry guiding plate 169 guides the recording sheet P and causes the leading edge of the recording sheet P to enter into the nip portion T of the fixing apparatus 17 in such a manner that wrinkles at fixing can be prevented.

The fixing apparatus 17 is composed of the first heat ray fixing roller 17a which is a roller-like rotation member for heat ray fixing on the upper side (obverse side) to fix the toner image of the obverse side image (upper surface side image), and the first fixing roller 47a which is a roller-like rotation member for fixing on the lower side (reverse side) to fix the toner image of the reverse side image (lower surface side image). The recording sheet P is nipped at the nip portion T having the width of about 2-10 mm, formed between the first heat ray fixing roller 17a and the first fixing roller 47a, and the toner image on the recording sheet P is fixed by being applied with heat and pressure. Inside the first heat ray fixing roller 17a, a heat ray irradiation member 171g, which is a heat ray irradiation means using, for example, halogen lamp or xenon lamp, which mainly emits heat rays such as infrared rays or far infrared rays, is provided.

Next, an image forming process will be described.

When image recording is stated, the photoreceptor drum 10 is rotated clockwise as shown by an arrow in FIG. 1 by the start of a photoreceptor driving motor, not shown, and simultaneously, application of potential voltage onto the photoreceptor drum 10 is started by charging action of the scorotron charger 11 of yellow (Y).

After the potential voltage is applied onto the photoreceptor drum 10, image writing by an electric signal corresponding to the first color signal, that is, Y image data is started by the Y exposure optical system 12, and an electrostatic latent image corresponding to a Y image of the document image is formed on the surface of the photoreceptor drum 10.

The latent image is reversal-developed under the non-contact condition by the Y developing device 13, and a toner image of yellow (Y) is formed on the photoreceptor drum 10.

Next, potential voltage is applied onto the photoreceptor drum 10 from above the Y toner image by the charging action of the magenta (M) scorotron charger 11, and image writing by an electric signal corresponding to the second color signal, that is, M image data is conducted by the M exposure optical system 12, and a toner image of magenta (M) is formed on the toner image of yellow (Y) by superimposition, by non-contact reversal development by the M developing device 13.

In the same process, by the cyan (C) scorotron charger 11, C exposure optical system 12 and C developing device 13, a toner image of cyan (C) corresponding to the third color signal is formed on the above toner images by superimposition, and further, by the black (K) scorotron charger 11, K exposure optical system 12 and K developing device 13, a toner image of black (K) corresponding to the fourth color signal is successively superimposed and formed thereon, and thus, superimposed color toner images of four colors of yellow(Y), magenta (M), cyan (C) and black (K) are formed on the peripheral surface of photoreceptor drum 10 during its one rotation (toner image forming means).

The image writing onto the photoreceptor layer of the photoreceptor drum 10 by the exposure optical systems 12 of Y, M, C and K is conducted from the inside of the drum through the above-described light transmissive base body. Accordingly, the image writing corresponding to the second, third and fourth color signals is conducted without any influence due to previously formed toner images, and the electrostatic latent image with the same quality as that of the image corresponding to the first color signal can be formed.

The superimposed color toner images, which become a reverse side image, formed on the photoreceptor drum 10, which is the image forming body, by the above image forming process, are collectively transferred onto the intermediate transfer belt 14a, which is the intermediate transfer body, by the transfer device 14c, which is the first transfer means, in the transfer area 14b, (primary transferring) (FIG. 2(A)). In this case, uniform exposure may be conducted by the transfer simultaneous exposure device 12d provided inside the photoreceptor drum 10 so that excellent transferring may be conducted.

Toner remaining on the peripheral surface of the photoreceptor drum 10 after transfer is discharged by the photoreceptor drum AC discharger 16, then, comes to a cleaning device 19, which is an image forming body cleaning means, and is cleaned by a cleaning blade 19a formed of rubber material, in contact with the photoreceptor drum 10, after that, the toner is collected in a waste toner container, not shown, by a screw 19b. Further, on the peripheral surface, of the photoreceptor drum 10, hysteresis of the photoreceptor drum 10 due to the previous image formation is erased by exposure by the uniform exposure device 12e before charging using, for example, light emitting diodes.

Electric charges of the intermediate transfer belt 14a charged by the transfer device 14c, are discharged by the discharger 14m serving as the discharging means provided in parallel to the transfer device 14c.

In the manner as described above, after the superimposed color toner image (the second toner image), which is the reverse side image, has been formed on the intermediate transfer belt 14a, in the same manner as the above-described color image forming process, a superimposed color toner image (the first toner image), which is the obverse side image, is succeedingly formed on the photoreceptor drum 10 (FIG. 2(B)). In this case, image data is changed so that the obverse side image formed on the photoreceptor drum 10 is a mirror image to the reverse side image formed on the photoreceptor drum 10.

Following to the obverse side image formation onto the photoreceptor drum 10, the recording sheet P, which is the transfer material, is sent from the sheet feed cassette 15, which is the transfer material accommodation means, by sending roller 15a, and conveyed to a timing roller 15b, which is the transfer material sending means, and the color toner image of the obverse side image, which is the first toner image, formed on the photoreceptor drum 10 is in timed relationship with the color toner image of the reverse side image, which is the second toner image, carried on the intermediate transfer belt 14a, by the drive of the timing roller 15b, and then, sent to the transfer area 14b. In this case, the sending recording sheet P is charged to the same polarity as that of toner by the paper charger 150, which is the transfer material charging means provided on the obverse side of the recording sheet P, attracted onto the intermediate transfer belt 14a, and is sent to the transfer area 14b. When the recording sheet P is paper-charged to the same polarity as that of toner, the recording sheet P is prevented from being attracted to the toner image on the intermediate transfer belt 14a or the toner image on the photoreceptor drum 10, resulting in prevention of toner image disturbance.

In the transfer area 14b, the obverse side image on the photoreceptor drum 10 is collectively transferred (second transferring) on the obverse side of the recording sheet P by the transfer device 14c, which is the second transfer means and onto which the voltage with the reverse polarity to that of toner (in the present example, positive polarity) is applied. In this case, the reverse side image on the intermediate transfer belt 14a is not transferred onto the recording sheet P and exists on the intermediate transfer belt 14a. In this case of the second transferring by the transfer device 14c serving as the second transfer means, uniform exposure may be conducted by the transfer simultaneous exposure device 12d using, for example, light emitting diodes, provided inside the photoreceptor drum 10 opposite to the transfer area 14b so that excellent transferring may be conducted. Further, electric charges of the intermediate transfer belt 14a charged by the transfer device 14c are discharged by the discharger 14m.

The recording sheet P onto the obverse side of which the color toner image is transferred, is conveyed to the reverse side transfer device 14g, serving as the third transfer means onto which the voltage of the reverse polarity to that of toner (in the present example, positive polarity) is applied, and the reverse side image on the peripheral surface of the intermediate transfer belt 14a is collectively transferred onto the reverse side of the recording sheet P (the third transferring) by the reverse side transfer device 14g (FIG. 2(C)).

The recording sheet P on both sides of which the color toner images are formed, is separated from the intermediate transfer belt 14a by curvature of the curvature portion KT of the intermediate transfer belt 14a, the discharging action by the paper separation AC discharger 14h serving as the transfer material separation means provided at need at the end portion of the intermediate transfer belt 14a, and by the separation claw 210 provided on the conveyance section 160 with a predetermined gap to the intermediate transfer belt 14a; stably conveyed to the fixing apparatus 17 through the spur 162 and the entry guiding plate 169 provided on the conveyance section 160; the leading edge portion of the recording sheet P is sent into the nip portion T of the fixing apparatus 17 by the entry guiding plate 169; and the toner image on the recording sheet P is fixed by being applied with heat and pressure at the nip portion T formed between the first heat ray fixing roller 17a located at the upper side to fix the toner image of the obverse side image (upper side image), and the first fixing roller 47a located at the lower side to fix the toner image of the reverse side image (lower side image). The obverse and reverse sides of the recording sheet P on which two-sided images are recorded, are reversed, and the recording sheet P is sent and delivered onto a tray outside the apparatus by the sheet delivery roller 18. Alternatively, a switching member, not shown, is provided at the exit of the fixing apparatus 17, as shown by a one-dotted chain line in FIG. 1, thereby the recording sheet P may be delivered onto the tray outside the apparatus without reversing the obverse and reverse sides of the recording sheet P.

The toner remaining on the peripheral surface of the intermediate transfer belt 14a after transfer is cleaned by an intermediate transfer body cleaning device 140, which is an intermediate transfer body cleaning means, provided in opposite to the driven roller 14e with the intermediate transfer belt 14a between these means, and has the intermediate transfer body cleaning blade 141, wherein cleaning blade 141 uses the support shaft 142 as a fulcrum of rotation and can be in contact with or contact-released from the intermediate transfer belt 14a.

Further, the toner remaining on the peripheral surface of the photoreceptor drum 10 after transfer is discharged by the photoreceptor drum AC discharger 16, and after that, hysteresis of the photoreceptor drum 10 due to the previous image formation is eliminated by a pre-charging uniform exposure device 12e, and the photoreceptor drum 10 enters the next image formation cycle.

When the above-described method is applied, the superimposed color toner images are collectively transferred, thereby, color doubling of the color image, toner scattering and rubbing on the intermediate transfer belt 14a hardly occur, and the excellent two-sided color image formation can be carried out with smaller image deterioration.

In the document image reading apparatus 500, in the case where image data is discriminated as one-side image or two-side image, when image data of the document PS read by the document image reading means shown in FIG. 3 is copied as the one-side image of only the obverse side by the photoreceptor drum 10, a one-side image formation program P2 of the obverse side by the photoreceptor drum 10 serving as the image forming body, which is stored in the ROM shown in FIG. 4, is read in the RAM through the control section, and the one-side image formation program P2 of the obverse side is carried out by the control section, and the image formation process of only the obverse side by the photoreceptor drum 10, described in FIG. 1, is continuously carried out.

Further, in the case where image data is discriminated as one-side image or two-side image, when image data of the document PS read by the document image reading means shown in FIG. 3 is copied as the one-side image of only the reverse side by the intermediate transfer belt 14a, a one-side image formation program P3 of the reverse side by the intermediate transfer belt 14a serving as the intermediate transfer body, which is stored in the ROM shown in FIG. 4, is read in the RAM through the control section, and the one-side image formation program P3 of the reverse side is carried out by the control section, and the image formation process of only the reverse side by the intermediate transfer belt 14a, described in FIG. 1, is continuously carried out.

As an example of the image forming apparatus to which the fixing apparatus of the present invention is applied, color image formation is described above, however, the present invention is not limited to that, but can also be applied to the one-side or two-side monochromatic image formation by the same process as described in FIGS. 1 and 2. Further, as an example of the image forming apparatus to which the fixing apparatus of the present invention is applied, the two-sided image forming apparatus is described, however, the present invention is not limited to that, and the fixing apparatus to be described below is described as the fixing apparatus for two-sided images, however, the present invention is not limited to this, but can also be used as the fixing apparatus for one-side image.

As shown in FIG. 5, the fixing apparatus 17 of the first example, is composed of the first heat ray fixing roller 17a which is used as the upper side (obverse side)fixing roller member to fix the toner image of the obverse side image (upper surface side image), and the first fixing roller 47a which is used as the lower side (reverse side)fixing roller member to fix the toner image of the reverse side image (lower surface side image). The recording sheet P is nipped at the nip portion T formed between the upper and lower fixing roller members, and the toner image on the recording sheet P is fixed by being applied with heat and pressure.

The first heat ray fixing roller 17a used for the upper side fixing roller member to fix the toner image of the obverse side image, is structured as a hard roller in which a heat-resistant resin layer 171e is formed on the outside (outer peripheral surface) of a cylindrical light transmissive base body 171a, and a cylindrical light transmissive base body for shaping 171A is formed by shaping the heat-resistant resin layer 171e; on the outside (outer peripheral surface) of the cylindrical light transmissive base body for shaping 171A, the heat ray absorption layer 171b is provided, and on the outside (outer peripheral surface) of the heat ray absorption layer 171b, a releasing layer 171c is provided; and a heat ray irradiation member 171g serving as the heat ray irradiation means using, for example, the halogen lamp or xenon lamp, is arranged inside the light transmissive base body for shaping 171A. Heat rays emitted from the heat ray irradiation member 17g are absorbed by the heat ray absorption layer 171b and a fixing roller member by which instantaneous heating can be carried out, is formed (the first example of the fixing roller member for instantaneous heating).

Further, the first fixing roller 47a used for the lower side fixing roller member to fix the toner image of the reverse side image, is structured as a soft roller in which a 2-20 mm thick rubber roller 471b is formed of a cylindrical metallic pipe 471a using, for example, aluminum material and for example, silicon material on the outer peripheral surface of the metallic pipe 471a; and a halogen heater 471c is arranged inside the metallic pipe 471a. Between the upper side hard roller and the lower side soft roller, a nip portion T having a convex portion on the lower side is formed, and thereby the toner image is fixed.

A symbol TS1 is a temperature sensor using, for example, a thermistor to control temperature, provided on the upper side first heat ray fixing roller 17a, and a symbol TS2 is a temperature sensor using, for example, a thermistor to control temperature, provided on the lower side first fixing roller 47a.

According to FIG. 7, the heat-resistant resin layer 171e is formed on the outside (outer peripheral surface) of the cylindrical light transmissive base body 171a, and the heat-resistant resin layer 171e is shaped and the cylindrical light transmissive base body for shaping 171A is made.

Initially, as the first method, the heat-resistant resin is coated on the outside (outer peripheral surface) of the cylindrical light transmissive base body 171a, and the cylindrical heat-resistant resin layer 171e is formed by heat polymerization or by spattering solvent, and after that, the cylindrical light transmissive base body for shaping 171A is formed by cutting and grinding the outer peripheral surface of the heat-resistant resin layer 171e so that the true circularity of the outer periphery is produced by defining the central axis of the inner peripheral surface of the light transmissive base body 171a as the reference, or the outer peripheral surface is made a smooth surface.

As the second method, the thermally fused resin solution is coated on the outside (outer peripheral surface) of the cylindrical light transmissive base body 171a, and the heat-resistant resin layer 171e is formed by cooling, and after that, the cylindrical light transmissive base body for shaping 171A is formed by cutting and grinding the outer peripheral surface of the heat-resistant resin layer 171e so that the true circularity of the outer periphery is produced by defining the central axis of the inner peripheral surface of the light transmissive base body 171a as the reference, or the outer peripheral surface is made a smooth surface.

As the third method, a silicon tube is covered on the outer peripheral surface of the cylindrical light transmissive base body 171a, and the heat-resistant resin layer 171e is formed by heat-contraction, and after that, the cylindrical light transmissive base body for shaping 171A is formed by cutting and grinding the outer peripheral surface of the heat-resistant resin layer 171e so that the true circularity of the outer periphery is produced by defining the central axis of the inner peripheral surface of the light transmissive base body 171a as the reference, or the outer peripheral surface is made a smooth surface.

According to the above processing, the cylindrical light transmissive base body which has no irregularity caused by the use of heat-resistant resins, and has a smooth outer peripheral surface and highly accurate true circularity can be obtained. That is, a cylindrical light transmissive base body for shaping which has no irregularity, and has a smooth outer peripheral surface and highly accurate true circularity can be obtained.

The structure of the first heat ray fixing roller 17a is as shown in a sectional view of FIG. 6(a). As the cylindrical light transmissive base body 171a of the cylindrical light transmissive base body for shaping 171A, the outer diameter φ is 15-60 mm, and the thickness t is 2-10 mm, and light transmissive resins using Pyrex glass, ceramic material such as sapphire (Al₂o₃), CaF₂, or polyimide, polyamide, through which heat rays such as infrared rays or far infrared rays from the heat ray irradiation member 171g pass, are used. Incidentally, the wavelength of heat ray which can passes through the light transmissive base body is 0.1-20 μm, preferably, 0.3-3 μm, and adjustment agents for hardness or thermal conductivity are added as a filler, however, the light transmissive base body 171a may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, not more than 1 μm, preferably 0.1 μm, and which are transmissive for heat rays (mainly, infrared rays or far infrared rays), are dispersed in a resin binder. In order to prevent light from scattering, and to make the heat ray reach the heat lay absorption layer 171b, it is preferable that the average particle size in the layer, including the primary and secondary particles, is not more than 1 μm, preferably, not more than 0.1 μm.

As the heat-resistant resin layer 171e of the cylindrical light transmissive base body for shaping 171A, the light transmissive resin using polyimide, polyamide, etc., is used, and it is coated with the thickness larger than the cutting margin to the surface layer of the light transmissive base body 171a, and the thickness after cutting is 50-1000 μm, preferably, 100-500 μm. Incidentally, the wavelength of heat ray which can passes through the heat-resistant resin layer 171e is 0.1-20 μm, preferably, 0.3-3 μm, and adjustment agents for hardness or thermal conductivity are added as a filler, however, the heat-resistant resin layer 171e may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, not more than 1 μm, preferably 0.1 μm, and which are transmissive for heat rays (mainly, infrared rays or far infrared rays), are dispersed in a resin binder. In order to prevent light from scattering, and to make the heat ray reach the heat lay absorption layer 171b, it is preferable that the average particle size, including the primary and secondary particles, is not more than 0.1-1 μm.

As the heat lay absorption layer 171b, a heat ray absorption member in which powders of carbon black, graphite, iron black (Fe₃O₄), or each kind of ferrite and its compounds, capper oxide, cobalt oxide, red oxide (Fe₂O₃), etc., are mixed into a resin binder, is used, and 10-200 μm thick, preferably, 20-100 μm thick heat ray absorption member is printed or coated on the outside (outer peripheral surface) of the shaped-transmissive material 171A, and thus the heat ray absorption layer 171b is formed, so that about 100% of heat rays, that is, 90-100%, preferably, 95-100% of heat rays, which are emitted from the heat ray irradiation member 171g, and which pass through the shaped-transmissive material 171A which is formed by shaping the heat-resistant resin layer 171e after the heat-resistant resin layer 171e is formed on the outside (outer peripheral surface) of the light transmissive base body 171a, are absorbed in the heat ray absorption layer 171b, and the fixing roller member by which instantaneous heating can be carried out, is formed. When heat ray absorption rate in the heat ray absorption layer 171b is lower than about 90%, for example, about 20-80%, heat rays leak, and in the case where the first heat ray fixing roller 17a, which is the fixing roller member, is used for the monochromatic image formation, when black toner adheres to the surface of the specific position of the first heat ray fixing roller 17a due to filming, heat is generated from the toner adhered portion due to leaking heat rays, and heat is further generated by the heat ray absorption at that portion, resulting in damage of the heat ray absorption layer 171b. Further, when the first heat ray fixing roller 17a is used for the color image formation, because absorption efficiency of color toner is generally low, and further, there is difference of absorption efficiency among color toners, fixing failure or uneven fixing occurs. Accordingly, the heat ray absorption rate of the heat ray absorption layer 171b is made 90-100% which corresponds to about 100%, and more preferably 95-100%, so that the heat rays emitted from the hear ray irradiation member 171g, and which pass through the light transmissive base body for shaping 171A, are perfectly absorbed in the first heat ray fixing roller 17a. Further, when the thickness of the heat ray absorption layer 171b is not larger than 10 μm, and thin, heating speed due to absorption of heat rays in the heat ray absorption layer 171b is high, however, local heating due to the thin film causes damage or insufficient strength of the heat ray absorption layer 171b, and when the thickness of the heat ray absorption layer 171b exceeds 200 μm, and too thick, insufficient heat conduction occurs, and thermal capacity becomes large and instantaneous heating hardly carried out. When the heat ray absorption rate of the heat ray absorption layer 171b is made 90-100% which corresponds to about 100%, and more preferably 95-100%, and the thickness of the heat ray absorption layer 171b is made 10-200 μm thick, preferably, 20-100 μm, local heat generation in the heat ray absorption layer 171b is prevented and uniform heat generation can be attained. Incidentally, the wavelength of heat ray which are emitted to the heat ray absorption layer 171b is 0.1-20 μm, preferably, 0.3-3 μm, and adjustment agents for hardness or thermal conductivity are added as a filler, however, the heat ray absorption layer 171b may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, not more than 1 μm, preferably 0.1 μm, and which are transmissive for heat rays (mainly, infrared ray or far infrared ray permeability), are dispersed in a resin binder in 5-50 weight %.

Further, being separated from the heat ray absorption layer 171b, the releasing layer 171c is provided in which 30-100 μm PFA (fluorine resin) tube is covered on the outside (outer peripheral surface) of the heat ray absorption layer 171b, or fluorine resin (PFA or PTFE) coating is coated thereon with 20-30 μm thickness, so that good releasability from toner is obtained,(separation type).

Further, as shown by the cross section in FIG. 6(b), the heat ray absorption member in which powders of carbon black, graphite, iron black (Fe₃O₄), or each kind of ferrite and its compounds, capper oxide, cobalt oxide, red oxide (Fe₂O₃), etc., are mixed, and fluorine resin (PFA or PTFE) coating used for both of a binder and releasing agent are mixed and blended, and the integrated heat ray absorption layer 171B having releasability in which the heat ray absorption layer 171b and the releasing layer 171c, which are described in FIG. 6(a), are integrated, is formed on the outside (outer peripheral surface) of the light transmissive base body for shaping 171A, and thus the fixing roller member is formed. In the same manner as described above, the heat ray absorption rate of the integrated heat ray absorption layer 171B is made 90-100% which corresponds to about 100%, and more preferably 95-100%, so that the heat rays emitted from the hear ray irradiation member 171g, and which pass through the light transmissive base body for shaping 171A, are perfectly absorbed. When heat ray absorption rate in the integrated heat ray absorption layer 171B is lower than about 90%, for example, about 20-80%, heat rays leak, and in the case where the fixing roller member is used for the monochromatic image formation, when black toner adheres to the surface of the specific position of the fixing roller member due to filming, heat is generated from the toner adhered portion due to leaking heat rays, and heat is further generated by the heat ray absorption at that portion, resulting in damage of the integrated heat ray absorption layer 171B. Further, when the fixing roller member is used for the color image formation, because absorption efficiency of color toner is generally low, and further, there is the difference of absorption efficiency among color toners, fixing failure or uneven fixing occurs. Accordingly, the heat ray absorption rate of the integrated heat ray absorption layer 171B is made 90-100% which corresponds to about 100%, and more preferably 95-100%, so that the heat rays emitted from the hear ray irradiation member 171g, and which pass through the light transmissive base body for shaping 171A, are perfectly absorbed in the fixing roller member. Further, the local heat generation in the integrated heat ray absorption layer 171B is also prevented and uniform heat generation is carried out. Further, the local heat generation in the integrated heat ray absorption layer 171B is prevented and uniform heat generation can be attained. Incidentally, the wavelength of heat ray which are emitted to the integrated heat ray absorption layer 171B is 0.1-20 μm, preferably, 0.3-3 μm, and adjustment agents for hardness or thermal conductivity are added as a filler, however, the integrated heat ray absorption layer 171B may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, not more than 1 μm, preferably 0.1 μm, and which are transmissive for heat rays (mainly, infrared ray or far infrared ray permeability), are dispersed in a resin binder in 5-50 weight %.

According to FIG. (8), it is preferable that heat is generated inside the heat ray absorption layer 171b by providing the density distribution of the heat ray absorption member in the heat ray absorption layer 171b of the first heat ray fixing roller 17a serving as the fixing roller member. The density distribution of the heat ray absorption member 171b is provided as shown by graph (A): the interface on the inscribed light transmissive base body for shaping is made low density which is gradually ascending toward the outer periphery side with inclination, and the density is saturated by absorbing 100% of heat rays at a position before the outer periphery side (at the position of about ⅔-⅘ from the light transmissive base body for shaping 171A side with respect to the thickness t of the heat ray absorption layer). According to that, the distribution of heat generation by the absorption of heat ray in the heat ray absorption layer 171b is formed into a parabola which has the maximum value in the vicinity o the central portion of the heat ray absorption layer 171b, and has the minimum value in the vicinity of the interface or the outer peripheral surface. Thereby, the heat generation by the heat ray absorption at the interface is decreased, and damage of the adhesive layer or breakage of the heat ray absorption layer 171b at the interface is prevented. Further, the density distribution from a position before the outer peripheral surface side(at the position of about ⅔-⅘ from the light transmissive base body for shaping 171A side with respect to the thickness t of the heat ray absorption layer) to the outer peripheral surface is made possible to be saturated, and for example, when the integrated heat ray absorption layer 171B is used, even if the outer peripheral surface layer is cut off, there is no influence. In this connection, as shown by a dotted line, a saturation layer may be formed. In conclusion, when heat rays are sufficiently absorbed at the inside, there is no influence of the density at the outside. There also be no influence of cutting. Further, the inclination is provided in the density distribution, and the distribution of the heat generation can be adjusted by changing the inclination angle.

Further, as shown in FIG. 9, the outer diameter φ of the cylindrical light transmissive base body for shaping 171A of the fist heat ray fixing roller 17a as the fixing roller member, a 15-60 mm base body is used, and as the thickness t thereof, the larger thickness is better for the strength, and the smaller thickness is better for the thermal capacity, and from the relationship between the strength and the thermal capacity, the relationship between the outer diameter φ of the cylindrical light transmissive base body for shaping 171A and the thickness t is expressed by the following relationship:

0.05≦t/φ≦0.20

and preferably,

0.07≦t/φ≦0.14

When the outer diameter φ of the cylindrical light transmissive base body for shaping 171A is 40 mm, the thickness t of the light transmissive base body for shaping 171A is 2 mm≦t≦8 mm , preferably, 2.8 mm≦t≦5.6 mm is used. When t/φ of the light transmissive base body for shaping 171A is not larger than 0.05, the strength is insufficient, and when t/φ exceeds 0.20, the thermal capacity becomes large, and heating of the first heat ray fixing roller 17a takes a long period of time. There is such a case that even the light transmissive base body absorbs about 1-20% heat rays depending on its material, and the thinner thickness is preferable within the range in which the strength can be maintained.

According to the above description, when the light transmissive base body for shaping 171A described in FIG. 7, and the fixing apparatus 17 described in FIG. 5 are used, the light transmissive base body with the highly accurate outer diameter is obtained, and such fixing roller member using heat rays for quick start fixing and fixing apparatus can be obtained that deformation at the fixing section (nip portion) hardly occurs, uneven fixing and fixing wrinkles do not occur, and instantaneous heating is possible or heating time period is short. Specifically, when these members are used for the image forming apparatus described in FIG. 1, quick start instantaneous heating for fixing of toner images can be carried out when the one-side image formation for obverse side image, whose frequency of use is large, is carried out, and energy saving effect can be obtained.

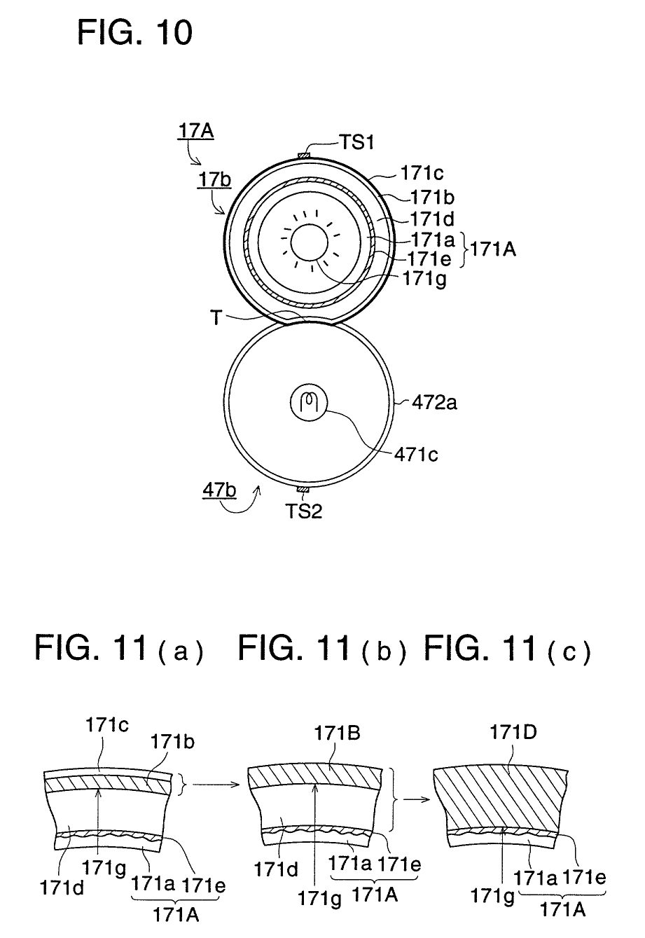

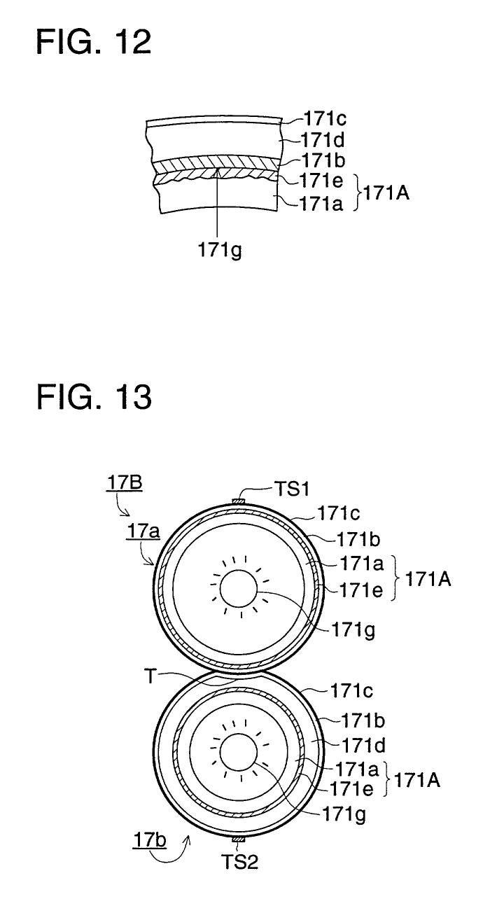

Referring to FIG. 10 through FIG. 12, another example of the fixing apparatus will be described below. FIG. 10 is an illustration showing the structure of the second example of the fixing apparatus, FIG. 11 is an enlarged structural sectional view of an upper side fixing roller member shown in FIG. 10, and FIG. 12 is an enlarged structural sectional view of an example of a modification of an upper side fixing roller member shown in FIG. 10.

As shown in FIG. 10, the fixing apparatus 17A of the second example, is composed of the second heat ray fixing roller 17b which is used as the upper side (obverse side)fixing roller member to fix the toner image of the obverse side image (upper surface side image), and the second fixing roller 47b which is used as the lower side (reverse side)fixing roller member to fix the toner image of the reverse side image (lower surface side image). The recording sheet P is nipped at the nip portion T formed between the upper and lower fixing roller members, and the toner image on the recording sheet P is fixed by being applied with heat and pressure.

The second heat ray fixing roller 17b used for the upper side fixing roller member to fix the toner image of the obverse side image, is structured as a soft roller in which a heat-resistant resin layer 171e is formed on the outside (outer peripheral surface) of a cylindrical light transmissive base body 171a, as described in FIG. 7, and a cylindrical light transmissive base body for shaping 171A is formed by shaping the heat-resistant resin layer 171e; on the outside (outer peripheral surface) of the cylindrical light transmissive base body for shaping 171A, the elastic layer 171d is provided, and on the outside (outer peripheral surface) of the elastic layer 171d, the heat ray absorption layer 171b is provided, and on the outside (outer peripheral surface) of the heat ray absorption layer 171b, a releasing layer 171c is provided; and a heat ray irradiation member 171g serving as the heat ray irradiation means using, for example, the halogen lamp or xenon lamp, is arranged inside the light transmissive base body for shaping 171A. Heat rays emitted from the heat ray irradiation member 17g are absorbed by the heat ray absorption layer 171b and a fixing roller member by which instantaneous heating can be carried out, is formed (the second example of the fixing roller member for instantaneous heating).

Further, the second fixing roller 47b used for the lower side fixing roller member to fix the toner image of the reverse side image, is structured as a hard roller which is formed of a cylindrical metallic pipe 472a using, for example, aluminum material or steel material, on the outer peripheral surface of which Teflon coat is printed or coated; and a halogen heater 471c is arranged inside the metallic pipe 472a. Between the upper side soft roller and the lower side hard roller, a nip portion T having a convex portion on the upper side is formed, and thereby the toner image is fixed.

A symbol TS1 is a temperature sensor using, for example, a thermistor to control temperature, provided on the upper side second heat ray fixing roller 17b, and a symbol TS2 is a temperature sensor using, for example, a thermistor to control temperature, provided on the lower side second fixing roller 47b.

According to FIG. 11, the structure of the second heat ray fixing roller 17b is as shown by a cross section in FIG. 11(a). As the cylindrical light transmissive base body 171a of the cylindrical light transmissive base body for shaping 171A, the outer diameter φ is 15-60 mm, and the thickness t is 2-10 mm, and light transmissive resins using Pyrex glass, ceramic material such as sapphire (Al₂o₃), CaF₂, or polyimide, polyamide, through which heat rays such as infrared rays or far infrared rays from the heat ray irradiation member 171g pass, are used. Incidentally, the wavelength of heat ray which can passes through the light transmissive base body is 0.1-20 μm, preferably, 0.3-3 μm, and adjustment agents for hardness or thermal conductivity are added as a filler, however, the light transmissive base body 171a may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, not more than 1 μm, preferably 0.1 μm, and which are transmissive for heat rays (mainly, infrared rays or far infrared rays), are dispersed in a resin binder. In order to prevent light from scattering, and to make the heat ray reach the heat lay absorption layer 171b, it is preferable that the average particle size in the layer φ, including the primary and secondary particles, is not more than 1 μm, preferably, not more than 0.1 μm.

As the heat-resistant resin layer 171e of the cylindrical light transmissive base body for shaping 171A, the light transmissive resin using polyimide, polyamide, etc., is used, and it is coated with the thickness larger than the cutting margin to the surface layer of the light transmissive base body 171a, and the thickness after cutting is 50-1000 μm, preferably, 100-500 μm. Incidentally, the wavelength of heat ray which can passes through the heat-resistant resin layer 171e is 0.1-20 μm, preferably, 0.3-3 μm, and adjustment agents for hardness or thermal conductivity are added as a filler, however, the heat-resistant resin layer 171e may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, not more than 1 μm, preferably 0.1 μm, and which are transmissive for heat rays (mainly, infrared rays or far infrared rays), are dispersed in a resin binder. In order to prevent light from scattering, and to make the heat ray reach the heat lay absorption layer 171b, it is preferable that the average particle size, including the primary and secondary particles, is not more than 1 μm, preferably, 0.1 μm.

The elastic layer 171d is formed of the heat ray transmissive rubber layer (base layer) through which the heat rays (mainly, infrared rays, or far infrared lays) pass, using, e.g., a silicon rubber having a thickness of, preferably, more than 0.5 mm, or further preferably 5-15 mm. As the elastic layer 171d, in order to correspond to the high speed processing, such a method is adopted that powders of metallic oxides such as silica, alumina, magnesium oxide, etc., are blended in the base rubber (silicon rubber) as a filler, and the thermal conductivity is improved, and a rubber layer having the thermal conductivity not less than 8.4×10⁻¹ W/(m° C.)is preferable. When the thermal conductivity is increased, generally, hardness of rubber tends to increase, and for example, the hardness of normally 40 Hs is increased near to 60 Hs (JIS, A rubber hardness). This base layer covers most part of the elastic layer 171d of the fixing roller member, and the amount of compression at the time of application of pressure is determined by the rubber hardness of the base layer. The intermediate layer of the elastic layer 171d is coated by fluorine rubber to 20-300 μm thickness as the oil resistance layer to prevent the oil from swelling. As the silicon rubber of the top layer of the elastic layer 171d, RTV (Room Temperature Vulcanizing) or LTV (Low Temperature Vulcanizing), which has better releasability than HTV (High Temperature Vulcanizing), is coated with the same thickness as that of the intermediate layer. Incidentally, the wavelength of heat ray which can passes through the elastic layer 171d is 0.1-20 μm, preferably, 0.3-3 μm, and the elastic layer 171d may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, the average particle size of which is not more than 1 μm, preferably 0.1 μm, and which are transmissive for heat rays (mainly, infrared rays or far infrared rays), are dispersed in a resin binder, as adjustment agents for hardness or thermal conductivity. In order to prevent light from scattering, and to make the heat ray reach the heat lay absorption layer 171b, it is preferable that the average particle size, including the primary and secondary particles, is not more than 1 μm, preferably, 0.1 μm.

As the heat lay absorption layer 171b, a heat ray absorption member in which powders of carbon black, graphite, iron black (Fe₃O₄), or each kind of ferrite and its compounds, capper oxide, cobalt oxide, red oxide (Fe₂O₃), etc., are mixed into a resin binder, is used, and 10-200 μm thick, preferably, 20-100 μm thick heat ray absorption member is printed or coated on the outside (outer peripheral surface) of the elastic layer 171d, and thus the heat ray absorption layer 171b is formed, so that about 100% of heat rays, that is, 90-100%, preferably, 95-100% of heat rays, which are emitted from the heat ray irradiation member 171g, and which pass through the shaped-transmissive material 171A which is formed by shaping the heat-resistant resin layer 171e after the heat-resistant resin layer 171e is formed on the outside (outer peripheral surface) of the light transmissive base body 171a, and the elastic layer 171d, are absorbed in the heat ray absorption layer 171b, and the fixing roller member by which instantaneous heating can be carried out, is formed. When heat ray absorption rate in the heat ray absorption layer 171b is lower than about 90%, for example, about 20-80%, heat rays leak, and in the case where the second heat ray fixing roller 17b, which is the fixing roller member, is used for the monochromatic image formation, when black toner adheres to the surface of the specific position of the second heat ray fixing roller 17b due to filming, heat is generated from the toner adhered portion due to leaking heat rays, and heat is further generated by the heat ray absorption at that portion, resulting in damage of the heat ray absorption layer 171b. Further, when the second heat ray fixing roller 17b is used for the color image formation, because absorption efficiency of color toner is generally low, and further, there is difference of absorption efficiency among color toners, fixing failure or uneven fixing occurs. Accordingly, the heat ray absorption rate of the heat ray absorption layer 171b is made 90-100% which corresponds to about 100%, and more preferably 95-100%, so that the heat rays emitted from the hear ray irradiation member 171g, and which pass through the elastic layer 171d, are perfectly absorbed in the second heat ray fixing roller 17b. Further, when the thickness of the heat ray absorption layer 171b is not larger than 10 μm, and thin, heating speed due to absorption of heat rays in the heat ray absorption layer 171b is high, however, local heating due to the thin film causes damage or insufficient strength of the heat ray absorption layer 171b, and when the thickness of the heat ray absorption layer 171b exceeds 200 μm, and too thick, insufficient heat conduction occurs, and thermal capacity becomes large and instantaneous heating hardly carried out. When the heat ray absorption rate of the heat ray absorption layer 171b is made 90-100% which corresponds to about 100%, and more preferably 95-100%, and the thickness of the heat ray absorption layer 171b is made 10-200 μm thick, preferably, 20-100 μm, local heat generation in the heat ray absorption layer 171b is prevented and uniform heat generation can be attained. Incidentally, the wavelength of heat ray which are emitted to the heat ray absorption layer 171b is 0.1-20 μm, preferably, 0.3-3 μm, and adjustment agents for hardness or thermal conductivity are added as a filler, however, the heat ray absorption layer 171b may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, including the primary and secondary particles, the average particle size of which is not more than 1 μm, preferably 0.1 μm, and which are transmissive for heat rays (mainly, infrared ray or far infrared ray permeability), are dispersed in a resin binder in 5-50 weight %.

Further, being separated from the heat ray absorption layer 171b, the releasing layer 171c is provided in which 30-100 μm PFA (fluorine resin) tube is covered on the outside (outer peripheral surface) of the heat ray absorption layer 171b, or fluorine resin (PFA or PTFE) coating is coated thereon with 20-30 μm thickness, so that good releasability from toner is obtained,(separation type).

Further, as shown by the cross section in FIG. 11(b), the heat ray absorption member in which powders of carbon black, graphite, iron black (Fe₃O₄), or each kind of ferrite and its compounds, capper oxide, cobalt oxide, red oxide (Fe₂O₃), etc., are mixed, and fluorine resin (PFA or PTFE) coating used for both of a binder and releasing agent are mixed and blended, and the integrated heat ray absorption layer 171B having releasability in which the heat ray absorption layer 171b and the releasing layer 171c, which are described in FIG. 11(a), are integrated, is formed on the outside (outer peripheral surface) of the elastic layer 171d formed on the outside (outer peripheral surface) of the light transmissive base body for shaping 171A, and thus the fixing roller member is formed. In the same manner as described above, the heat ray absorption rate of the integrated heat ray absorption layer 171B is made 90-100% which corresponds to about 100%, and more preferably 95-100%, so that the heat rays emitted from the heat ray irradiation member 171g, and which pass through the light transmissive base body for shaping 171A and the elastic layer 171d, are perfectly absorbed. When heat ray absorption rate in the integrated heat ray absorption layer 171B is lower than about 90%, for example, about 20-80%, heat rays leak, and in the case where the fixing roller member is used for the monochromatic image formation, when black toner adheres to the surface of the specific position of the fixing roller member due to filming, heat is generated from the toner adhered portion due to leaking heat rays, and heat is further generated by the heat ray absorption at that portion, resulting in damage of the integrated heat ray absorption layer 171B. Further, when the fixing roller member is used for the color image formation, because absorption efficiency of color toner is generally low, and further, there is difference of absorption efficiency among color toners, fixing failure or uneven fixing occurs. Accordingly, the heat ray absorption rate of the integrated heat ray absorption layer 171B is made 90-100% which corresponds to about 100%, and more preferably 95-100%, so that the heat rays emitted from the heat ray irradiation member 171g, and which pass through the light transmissive base body for shaping 171A, are perfectly absorbed in the fixing roller member. Further, the local heat generation in the integrated heat ray absorption layer 171B is also prevented and uniform heat generation is carried out. Incidentally, the wavelength of heat rays which are emitted to the integrated heat ray absorption layer 171B is 0.1-20 μm, preferably, 0.3-3 μm, and adjustment agents for hardness or thermal conductivity are added as a filler, however, the integrated heat ray absorption layer 171B may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, including the primary and secondary particles, the average particle size of which is not more than 1 μm, preferably 0.1 μm, and which are transmissive for heat rays (mainly, infrared ray or far infrared ray permeability), are dispersed in a resin binder.

Further, as shown by the cross section in FIG. 11(c), the heat ray absorption member in which powders of carbon black, graphite, iron black (Fe₃O₄), or each kind of ferrite and its compounds, capper oxide, cobalt oxide, red oxide (Fe₂O₃), etc., are mixed, and fluorine resin (PFA or PTFE) coating used for both of a binder and releasing agent are further mixed and blended with silicon rubber, and the integrated elastic layer 171D used also for the heat ray absorption layer, in which the elastic layer 171d and the integrated heat ray absorption layer 171B, described in FIG. 11(b), are integrated, is formed on the outside (outer peripheral surface) of the light transmissive base body for shaping 171A, and thus the fixing roller member is formed. In the same manner as described above, the heat ray absorption rate of the integrated elastic layer 171D used also for the heat ray absorption layer is made 90-100% which corresponds to about 100%, and more preferably 95-100%, so that the heat rays emitted from the hear ray irradiation member 171g, and which pass through the light transmissive base body for shaping 171A, are perfectly absorbed in the fixing roller member. When heat ray absorption rate in the integrated elastic layer 171D is lower than about 90%, for example, about 20-80%, heat rays leak, and in the case where the fixing roller member is used for the monochromatic image formation, when black toner adheres to the surface of the specific position of the fixing roller member due to filming, heat is generated from the toner adhered portion due to leaking heat rays, and heat is further generated by the heat ray absorption at that portion, resulting in damage of the integrated elastic layer 171D. Further, when the fixing roller member is used for the color image formation, because absorption efficiency of color toner is generally low, and further, there is difference of absorption efficiency among color toners, fixing failure or uneven fixing occurs. Accordingly, the heat ray absorption rate of the integrated elastic layer 171D is made 90-100% which corresponds to about 100%, and more preferably 95-100%, so that the heat rays emitted from the hear ray irradiation member 171g, and which pass through the light transmissive base body for shaping 171A, are perfectly absorbed in the fixing roller member. Further, the local heat generation in the integrated elastic layer 171D is also prevented and uniform heat generation is carried out. Incidentally, the wavelength of heat rays which are emitted to the integrated elastic layer 171D is 0.1-20 μm, preferably, 0.3-3 μm, and adjustment agents for hardness or thermal conductivity are added as a filler, however, the integrated elastic layer 171D may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of heat rays, that is, including the primary and secondary particles, the average particle size of which is not more than 1 μm, preferably 0.1 μm, and which are transmissive for heat rays (mainly, infrared ray or far infrared ray permeability), are dispersed in a resin binder.

In also the heat ray absorption layer 171b, the integrated heat ray absorption layer 171B, or the integrated elastic layer 171D of the second heat ray fixing roller 17b serving as the fixing roller member, it is preferable that heat is generated inside the heat ray absorption layer 171b by providing the density distribution of the heat ray absorption member as described in FIG. 8. Thereby, the heat generation by the heat ray absorption at respective interfaces with the light transmissive base body for shaping 171A is decreased, and damage of the adhesive layer or breakage of the heat ray absorption layer 171b, the integrated heat ray absorption layer 171B, or the integrated elastic layer 171D is prevented. Further, the density distribution from a position before the outer peripheral surface side of the integrated heat ray absorption layer 171B, or the integrated elastic layer 171D (at the position of about ⅔-⅘ from the light transmissive base body for shaping 171A side with respect to the thickness t of the integrated heat ray absorption layer 171B, or the integrated elastic layer 171D) to the outer peripheral surface is made such that the density is provided to absorb 100% of heat rays at that position, and the density distribution is saturated, and when the integrated heat ray absorption layer 171B or the integrated elastic layer 171D is used, even if the outer peripheral surface layer is cut off, there is no influence. In the case of the separation type one, it is not necessary to provide the saturation layer. Further, the inclination is provided in the density distribution, and the distribution of the heat generation can be adjusted by changing the inclination angle. Further, as shown in FIG. 9, the relationship between the outer diameter φ and the thickness t of the cylindrical light transmissive base body for shaping 171A, in which a 15-60 mm φ base body is used, is expressed by the following relationship:

0.05≦t/φ≦0.20

and preferably,

0.07≦t/φ≦0.14

When the outer diameter φ of the cylindrical light transmissive base body for shaping 171A is 40 mm, the thickness t of the light transmissive base body for shaping 171A is 2 mm≦t≦8 mm, preferably, 2.8 mm≦t≦5.6 mm is used. When t/φ of the light transmissive base body for shaping 171A is not larger than 0.05, the strength is insufficient, and when t/φ exceeds 0.20, the thermal capacity becomes large, and heating of the second heat ray fixing roller 17a takes a long period of time. There is such a case that even the light transmissive base body absorbs about 1-20% heat rays depending on its material, and the thinner thickness is preferable within the range in which the strength can be maintained.

According to the above description, when the light transmissive base body for shaping 171A described in FIG. 7, and the fixing apparatus 17A described in FIG. 10 are used, the light transmissive base body with the highly accurate outer diameter is obtained, and such fixing apparatus can be obtained that deformation at the fixing section (nip portion) hardly occurs, and quick start fixing can be attained. Specifically, when these members are used for the image forming apparatus described in FIG. 1, quick start and instantaneous heating fixing of toner images can be carried out when the one-side image formation for obverse side image, whose frequency of use is large, is carried out, and energy saving effect can be obtained.

As shown in FIG. 12, as an example of modifications of the upper fixing roller member to fix the toner image of the obverse side image, the upper side fixing roller member may be structured as a soft roller in which a heat-resistant resin layer 171e is formed on the outside (outer peripheral surface) of a cylindrical light transmissive base body 171a, as described in FIG. 7, and a light transmissive base body for shaping 171A is formed by shaping the heat-resistant resin layer 171e; on the outside (outer peripheral surface) of the light transmissive base body for shaping 171A, the heat ray absorption layer 171b, the elastic layer 171d, and the releasing layer 171c are provided in that order; and a heat ray irradiation member 171g serving as the heat ray irradiation means using, for example, the halogen lamp or xenon lamp, is arranged inside the light transmissive base body for shaping 171A. The same materials and structures of the light transmissive base body 171a, the heat-resistant resin layer 171e, the heat ray absorption layer 171b, the elastic layer 171d, and the releasing layer 171c as described in FIG. 11(a) are used.

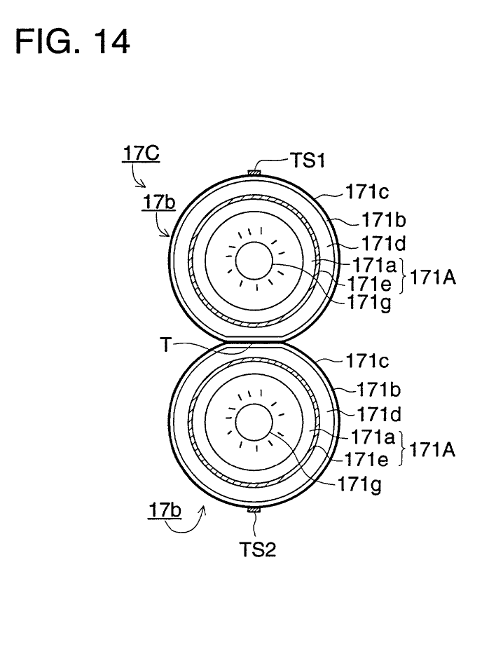

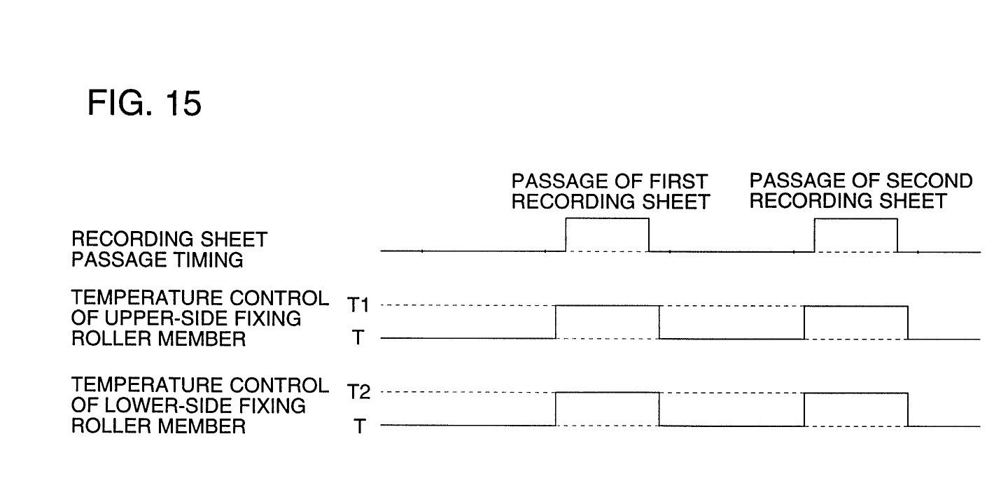

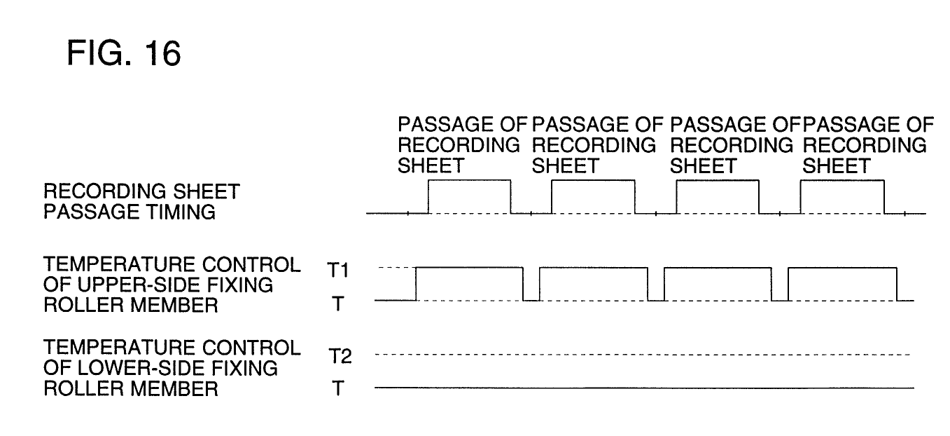

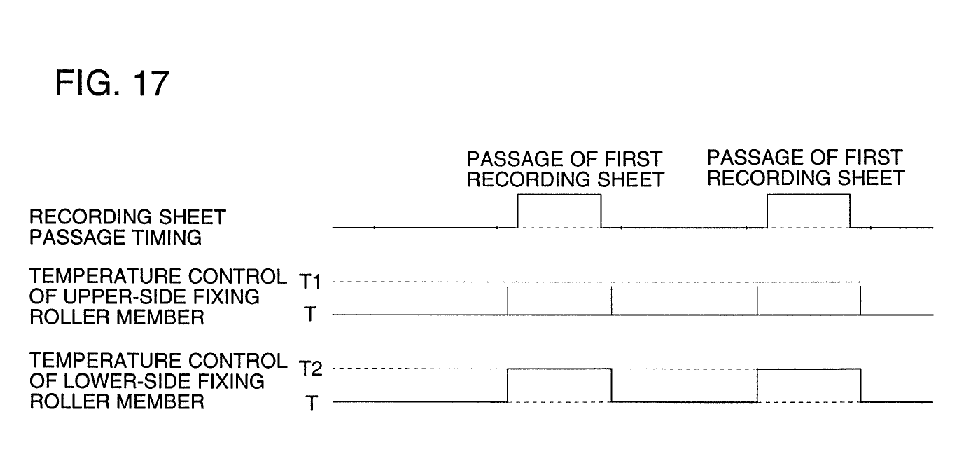

Referring to FIG. 13 through FIG. 17, a fixing apparatus for two-side fixing using the fixing roller member for instantaneous heating which is described in FIG. 10 or FIG. 5, and its temperature control will be described below. FIG. 13 is a view showing the third example of the fixing apparatus for two-side fixing using a pair of the fixing roller member for instantaneous heating of the first example and the fixing roller member for instantaneous heating of the second example. FIG. 14 is a view showing the fourth example of the fixing apparatus for two-side fixing using a pair of the fixing roller members for instantaneous heating of the second example. FIG. 15 is a temperature control timing chart at the time of two-sided image formation using the fixing apparatus of the third example or the fourth example. FIG. 16 is a temperature control timing chart at the time of the one-side obverse image formation using the fixing apparatus of the third example or the fourth example. FIG. 17 is a temperature control timing chart at the time of the one-side reverse image formation using the fixing apparatus of the third example or the fourth example.

As shown in FIG. 13, the fixing apparatus 17B of the third example as an example of the fixing apparatus using the fixing roller member for instantaneous heating for the two-side fixing, is composed of the first heat ray fixing roller 17a (the first example of the fixing roller member for instantaneous heating) which is the same roller member as described in FIG. 5 as the upper side (obverse side)fixing roller member to fix the toner image of the obverse side image (upper surface side image), and the second heat ray fixing roller 17b (the second example of the fixing roller member for instantaneous heating) which is the same roller member as described in FIG. 10 as the lower side (reverse side)fixing roller member to fix the toner image of the reverse side image (lower surface side image). The recording sheet P is nipped at the nip portion T formed between the upper and lower fixing roller members, and the toner image on the recording sheet P is fixed by being applied with heat and pressure.

The first heat ray fixing roller 17a used for the upper side fixing roller member to fix the toner image of the obverse side image, is structured as a hard roller in which a heat-resistant resin layer 171e is formed on the outside (outer peripheral surface) of a cylindrical light transmissive base body 171a described in FIG. 7, and a cylindrical light transmissive base body for shaping 171A is formed by shaping the heat-resistant resin layer 171e; on the outside (outer peripheral surface) of the cylindrical light transmissive base body for shaping 171A, the heat ray absorption layer 171b, and the releasing layer 171c are provided in that order; and a heat ray irradiation member 171g serving as the heat ray irradiation means using, for example, the halogen lamp or xenon lamp, is arranged inside the light transmissive base body for shaping 171A. Heat rays emitted from the heat ray irradiation member 17g are absorbed by the heat ray absorption layer 171b and a fixing roller member by which instantaneous heating can be carried out, is formed (the first example of the fixing roller member for instantaneous heating). The fixing roller member for instantaneous heating using the above-described integrated heat ray absorption layer 171B is also used as the upper fixing roller member.

The second heat ray fixing roller 17b used for the lower side fixing roller member to fix the toner image of the reverse side image, is structured as a soft roller in which a heat-resistant resin layer 171e is formed on the outside (outer peripheral surface) of a cylindrical light transmissive base body 171a described in FIG. 7, and a cylindrical light transmissive base body for shaping 171A is formed by shaping the heat-resistant resin layer 171e; on the outside (outer peripheral surface) of the cylindrical light transmissive base body for shaping 171A, the elastic layer 171d, the heat ray absorption layer 171b, and the releasing layer 171c are provided in that order; and a heat ray irradiation member 171g serving as the heat ray irradiation means using, for example, the halogen lamp or xenon lamp, is arranged inside the light transmissive base body for shaping 171A. Heat rays emitted from the heat ray irradiation member 17g are absorbed by the heat ray absorption layer 171b and a fixing roller member by which instantaneous heating can be carried out, is formed (the second example of the fixing roller member for instantaneous heating). The fixing roller member for instantaneous heating using the above-described integrated heat ray absorption layer 171B or the integrated elastic layer 171D is also used as the lower fixing roller member.

Between the upper side hard roller and the lower side soft roller, a nip portion T having a convex portion on the lower side is formed, and thereby the toner image is fixed. A symbol TS1 is a temperature sensor using, for example, a thermistor to control temperature, provided on the upper side first heat ray fixing roller 17a, and a symbol TS2 is a temperature sensor using, for example, a thermistor to control temperature, provided on the lower side second heat ray fixing roller 17b.

As shown in FIG. 14, the fixing apparatus 17C of the fourth example as another example of the fixing apparatus using the fixing roller member for instantaneous heating for the two-side fixing, is composed of the second heat ray fixing rollers 17b (the second example of the fixing roller member for instantaneous heating) which are the same roller members as described in FIG. 10 as the upper side (obverse side)fixing roller member to fix the toner image of the obverse side image (upper surface side image), or the lower side (reverse side)fixing roller member to fix the toner image of the reverse side image (lower surface side image). The recording sheet P is nipped at the nip portion T formed between the upper and lower fixing roller members, and the toner image on the recording sheet P is fixed by being applied with heat and pressure.

The second heat ray fixing roller 17b used for the upper side fixing roller member to fix the toner image of the obverse side image, or the lower side fixing roller member to fix the toner image of the reverse side image, is structured as a soft roller in which a heat-resistant resin layer 171e is formed on the outside (outer peripheral surface) of a cylindrical light transmissive base body 171a described in FIG. 7, and a cylindrical light transmissive base body for shaping 171A is formed by shaping the heat-resistant resin layer 171e; on the outside (outer peripheral surface) of the cylindrical light transmissive base body for shaping 171A, the elastic layer 171d, the heat ray absorption layer 171b, and the releasing layer 171c are provided in that order; and a heat ray irradiation member 171g serving as the heat ray irradiation means using, for example, the halogen lamp or xenon lamp, is arranged inside the light transmissive base body for shaping 171A. Heat rays emitted from the heat ray irradiation member 17g are absorbed by the heat ray absorption layer 171b and a fixing roller member by which instantaneous heating can be carried out, is formed (the second example of the fixing roller member for instantaneous heating). The fixing roller member for instantaneous heating using the above-described integrated heat ray absorption layer 171B or the integrated elastic layer 171D is also used as the upper or the lower fixing roller member.

Between the upper side and the lower side soft rollers, a plane-like nip portion T is formed, and thereby the toner image is fixed. A symbol TS1 is a temperature sensor using, for example, a thermistor to control temperature, provided on the upper side second heat ray fixing roller 17b, and a symbol TS2 is a temperature sensor using, for example, a thermistor to control temperature, provided on the lower side second heat ray fixing roller 17b.

The fixing temperature control when the fixing apparatus 17B or fixing apparatus 17C shown in FIG. 13 or FIG. 14 is applied to the image forming apparatus for two-sided image formation shown in FIG. 1, will be described below.

As shown in FIG. 15, in the case of two-sided image formation, the conveyance timing of the recording sheet P passing through the fixing apparatus 17B or fixing apparatus 17C corresponding to the obverse and reverse side image formation by the photoreceptor drum 10 is intermittent and for every other sheet, which is different from that of continuous printing by the obverse single-side image formation. The upper side fixing roller member to fix the toner image of the obverse side image (in the case of the fixing apparatus 17B, the first heat ray fixing roller 17a, and in the case of the fixing apparatus 17C, the second heat ray fixing roller 17b) is in timed relationship with the passage timing of the recording sheet P, and the heat ray irradiation member 171g serving as the upper side heat ray irradiation means is turned on and the roller member is heated, and the temperature control of the upper side fixing roller member on respective levels of the fixing temperature setting value T during stoppage of the image formation and the appropriate fixing temperature setting value T2 during image formation is alternately conducted.

In the same manner, the lower side fixing roller member to fix the toner image of the reverse side image (in both of the case of the fixing apparatus 17B and the case of the fixing apparatus 17C, the second heat ray fixing roller 17b) is in timed relationship with the passage timing of the recording sheet P, and the heat ray irradiation member 171g serving as the heat ray irradiation means is turned on and the roller member is heated, and the temperature control of the lower side fixing roller member on respective levels of the fixing temperature setting value T during stoppage of the image formation and the appropriate fixing temperature setting value T2 during image formation is alternately conducted. In this case, the two-sided image formation is conducted intermittently for every other sheet, and non-passage time period of the recording sheet P is long, thereby, the temperature control can be carried out, temperature can be made uniform, and even by the upper and lower fixing roller members for instantaneous heating with small thermal capacity, the two-sided image can be fixed.

The temperature control is conducted by the control section through the comparator circuit by using fixing temperature setting values T, T1, T2 previously stored in the ROM and detection by temperature sensors TS1 and TS2 (refer to FIG. 4).

In FIG. 15, the temperature control of the upper and lower fixing roller members is conducted at the area in which the leading and trailing edges of the recording sheet P are nipped, and when the line speed is high, the temperature control timing is set a little earlier, and further, it is necessary that the setting values are always set to T1 and T2 even during printing operation.

Further, as shown in FIG. 16, in the case of the obverse one-side image formation, the conveyance timing of the recording sheet P passing through the fixing apparatus 17B or fixing apparatus 17C in the obverse side image formation by the photoreceptor drum 10 is continuous corresponding to continuous obverse side image formation by the photoreceptor drum 10, which is different from that of continuous printing in two-sided image formation or the reverse one-side image formation. The upper side fixing roller member to fix the toner image of the obverse side image (in the case of the fixing apparatus 17B, the first heat ray fixing roller 17a, and in the case of the fixing apparatus 17C, the second heat ray fixing roller 17b) is in timed relationship with the passage timing of the recording sheet P, and the heat ray irradiation member 171g serving as the upper side heat ray irradiation means is turned on and the roller member is heated, and the temperature control of the upper side fixing roller member on respective levels of the fixing temperature setting value T during stoppage of the image formation and the appropriate fixing temperature setting value T2 during image formation is alternately conducted. The heating temperature control of the upper side fixing roller member is conducted in such a manner that, during copying by the obverse one-side image formation, the heat ray irradiation member 171g is turned on and the roller member is heated before the passage of the recording sheet P, and appropriate fixing temperature setting value T1 during image formation is maintained.

In contrast to this, the lower side fixing roller member (in both cases of the fixing apparatus 17B and the fixing apparatus 17C, the second heat ray fixing roller 17b) is not subjected to heating control during copying by the obverse one-side image formation, and is not subjected to any additional operation. Alternatively, temperature control of the lower side fixing roller member is conducted so that the temperature is maintained at the fixing temperature setting value T during stoppage of image formation.

The temperature control is conducted by the control section through the comparator circuit by using fixing temperature setting values T and T1 previously stored in the ROM and detection by temperature sensors TS1 and TS2 (refer to FIG. 4).

In FIG. 16, the temperature control of the upper side fixing roller member is conducted at the area in which the leading and trailing edges of the recording sheet P are nipped, and when the line speed is high, it is necessary that the temperature control timing is set a little earlier, and further, the setting value is always set to T1 even during printing operation.

As shown in FIG. 17, in the case of reverse one-side image formation, the conveyance timing of the recording sheet P passing through the fixing apparatus 17B or fixing apparatus 17C corresponding to the reverse side image formation by the intermediate transfer belt 14a is intermittent and for every other sheet, which is different from that of continuous printing by the obverse single-side image formation. The lower side fixing roller member to fix the toner image of the reverse side image (in both cases of the fixing apparatus 17B and the fixing apparatus 17C, the second heat ray fixing roller 17b) is in timed relationship with the passage timing of the recording sheet P, and the heat ray irradiation member 171g serving as the lower side heat ray irradiation means is turned on and the roller member is heated, and the temperature control of the lower side fixing roller member on respective levels of the fixing temperature setting value T during stoppage of the image formation and the appropriate fixing temperature setting value T2 during image formation is alternately conducted. The heating temperature control of the lower side fixing roller member is conducted in such a manner that, during copying by the reverse one-side image formation, the heat ray irradiation member 171g is turned on and the roller member is heated before the passage of the recording sheet P, and appropriate fixing temperature setting value T2 during image formation is maintained.

In contrast to this, the upper side fixing roller member is not subjected to heating control during copying by the reverse one-side image formation, and is not subjected to any additional operation. Alternatively, temperature control of the lower side fixing roller member is conducted so that the temperature is maintained at the fixing temperature setting value T during stoppage of image formation.

In the upper side fixing roller member, as shown by one-dotted chain line in FIG. 17, it is more preferable that the heat ray irradiation member 171g is turned on before the passage of the recording sheet P, and heating is carried out so that the temperature is kept at the appropriate fixing temperature setting value T1 during image formation, while copy is carried out by the reverse one-side image formation. The upper side fixing roller member is turned on and heated, the leading edge of the nip portion T is heated and when the leading edge of the recording sheet P is nipped in the nip portion, the toner image is not disturbed, thereby, fixing of the toner image of the reverse and one-side image is carried out satisfactorily.

The temperature control is conducted by the control section through the comparator circuit by using fixing temperature setting values T, T2, (T1) previously stored in the ROM and detection by temperature sensors TS1 and TS2 (refer to FIG. 4).

In FIG. 17, the temperature control of the upper side fixing roller member and the lower side fixing roller member is conducted at the area in which the leading and trailing edges of the recording sheet P are nipped, and when the line speed is high, it is necessary that the temperature control timing is set a little earlier, and further, the setting values are always set to T1 and T2 even during printing operation.

According to FIGS. 15 through 17, at the time of the obverse one-side image formation, the reverse one-side image formation, or the two-sided image formation, the toner image fixing is conducted by the upper and lower fixing roller members for instantaneous heating, which has small thermal capacity and by which quick start is possible, thereby, fixing is conducted satisfactorily without warming-up time. Particularly, the two-sided image formation or the reverse one-side image formation is conducted intermittently and for every other sheet, therefore, for the reverse side toner image fixing, the thermal capacity is enough even by the lower side fixing roller member whose thermal capacity is smaller than that of the conventional thermal fixing roller, thereby, the fixing of the reverse side image can be conducted by the lower side fixing roller member.

In this connection, the image forming apparatus can be set such that the temperature control is automatically conducted to be the condition of the two-sided image formation, at the time of the initial operation when the power switch is turned on, or when the mode is changed from the stop mode to the printing operation mode, or the image forming apparatus can be controlled such that the heating control of the upper and lower fixing roller members is turned off when stopping time is over a predetermined time period.

According to the above-described structure, respectively different amount energy is consumed at the time of only obverse one-side image formation, at the time of only reverse one-side image formation, or at the time of two-sided image formation, and respectively more appropriate amount of energy is consumed at the time of one-side image formation, and at the time of two-sided image formation as compared to those of the conventional fixing apparatus using the heat generation body in the upper and lower rollers. Therefore, energy consumption is decreased in both cases, and the nip width in the fixing area is wider, and the higher fixing property can be obtained as compared to the conventional fixing apparatus using the heat generation body in the upper and lower rollers or the fixing apparatus using the ceramic heater, thereby, the fixing apparatus which has low thermal capacity, almost zero warming-up time period and which can fix the two-sided images, is provided.

As described above, when the fixing apparatus 17B or the fixing apparatus 17C, which are described in FIGS. 13 and 14, are used, the fixing roller member and fixing apparatus, which are hardly deformed at the fixing section (nip portion), do not cause uneven fixing or fixing wrinkles, and provide quick start fixing by instantaneous heating, can be realized, and as described above, particularly when these are used for the image forming apparatus described in FIG. 1, quick starting and instantaneous heating of the toner image fixing at two-sided image formation can be attained, and the energy saving effect can be obtained.

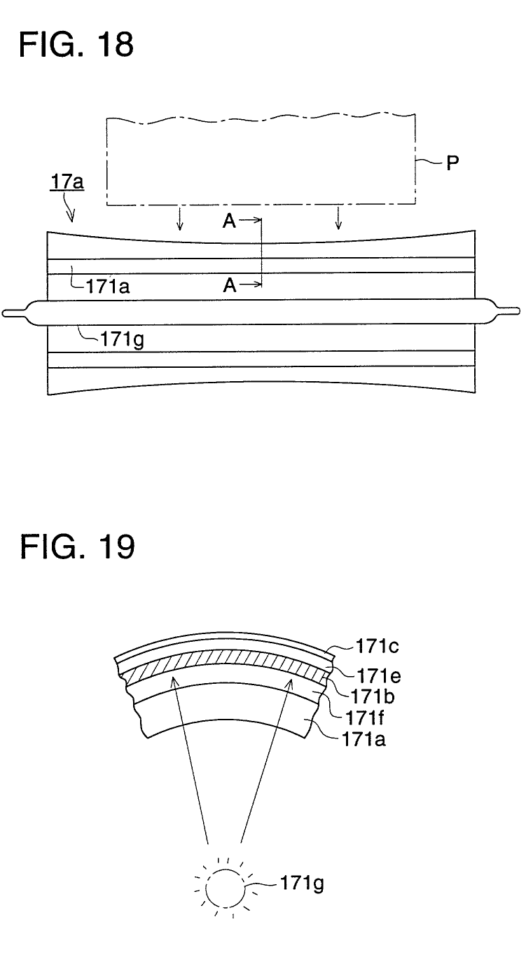

As described above, the fixing apparatus 17 is composed of the first heat ray fixing roller 17a which is the upper side (obverse side) roller-like heat ray fixing rotation member to fix the toner image of the obverse side image (upper surface side image), and the first fixing roller 47a which is the lower side (reverse side) roller-like fixing rotation member to fix the toner image of the reverse side image (lower surface side image). The recording sheet P is nipped at the nip portion T formed between the first heat ray fixing roller 17a and first fixing roller 47a, and the toner image on the recording sheet P is fixed by being applied with heat and pressure. As shown in FIG. 18, by the reverse crown-shape formed on each member layer provided on the outside (outer peripheral surface) of the light transmissive base body 171a, the first heat ray fixing roller 17a as the heat ray fixing rotation member is formed into the reverse crown-shape. By the reverse crown provided on the first heat ray fixing roller 17a as the heat ray fixing rotation member, the recording sheet P to be fixed is conveyed such that the recording sheet P is expanded from the center toward both ends, and generation of wrinkles of the transfer material is prevented at the time of toner image fixing.

The first heat ray fixing roller 17a used for the heat ray fixing rotation member is structured, as shown by the cross section shown in FIG. 19, as a hard roller which is composed of a cylindrical heat transmissive base body 171a, and on the outside (outer peripheral surface) of which a light transmissive layer for shaping 171f, a heat-resistant absorption layer 171b, a heat conductive layer 171e, and a releasing layer 171c are provided in that order. The first heat ray fixing roller 17a as the heat ray fixing rotation member with the reverse crown-shape is formed by providing the reverse crown-shape on any of the light transmissive layer for shaping 171f, the heat-resistant absorption layer 171b, the heat conductive layer 171e, or the releasing layer 171c, which are provided on the outside (outer peripheral surface) of the light transmissive base body 171a. The heat ray irradiation member 171g serving as the heat ray irradiation means using, for example, the halogen lamp or xenon lamp, which mainly emits infrared rays or far infrared rays, is arranged inside the light transmissive base body 171a. Heat rays emitted from the heat ray irradiation member 17g are absorbed by the heat ray absorption layer 171b and a heat ray fixing rotation member by which instantaneous heating can be carried out, is formed (the first example of the heat ray fixing rotation member for instantaneous heating).

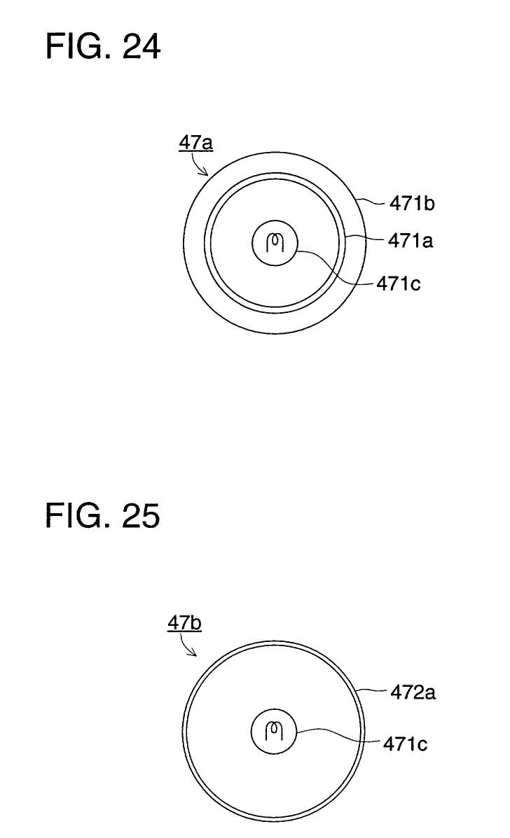

Further, the first fixing roller 47a used for the roller-like fixing rotation member to fix the toner image of the reverse side image, is structured as a soft roller which is, as shown by a cross section in FIG. 24, composed of a cylindrical metallic pipe 471a using, for example, aluminum material, and on the outer peripheral surface of which a 2-20 mm thick rubber roller 471b is formed of, for example, silicon material. A halogen heater 471c is arranged inside the metallic pipe 471a.

According to FIG. 19, as the cylindrical light transmissive base body 171a constituting the first heat ray fixing roller 17a, Pyrex glass, ceramic material such as sapphire (Al₂o₃), CaF₂, (the thermal conductivity is (5.5-19.0)×10⁻³ J/cm·s·k) or light transmissive resins using polyimide, polyamide, (the thermal conductivity is (2.5-3.4)×10⁻³ J/cm·s·k), through which heat rays such as infrared rays or far infrared rays from the heat ray irradiation member 171g pass, are used. Incidentally, the wavelength of heat ray which can passes through the light transmissive base body is 0.1-20 μm, preferably, 0.3-3 μm, and adjustment agents for hardness or thermal conductivity are added as a filler, however, the light transmissive base body 171a may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, not more than 1 μm, preferably 0.1 μm, and which are transmissive for heat rays (mainly, infrared rays or far infrared rays), are dispersed in a resin binder. In order to prevent light from scattering, and to make the heat ray reach the heat ray absorption layer 171b, it is preferable that the average particle size in the layer, including the primary and secondary particles, is not more than 1 μm, preferably, not more than 0.1 μm. Accordingly, the thermal conductivity of the light transmissive base body 171a is not so good.

As the light transmissive layer for shaping 171f, the heat-resistant light transmissive resin such as polyimide, or polyamide is used, and the light transmissive layer for shaping 171f is formed on the outside (outer peripheral surface) of the light transmissive base body 171a in such a manner that the heat-resistant resin is coated on outer peripheral surface of the cylindrical light transmissive base body 171a, and the cylindrical, shaped-heat-resistant resin layer 171f is formed by heat polymerization or by spattering solvent; heated and fused resin solution is coated on outer peripheral surface of the cylindrical light transmissive base body 171a; and the shaped-heat-resistant resin layer 171f is formed by cooling; and a silicon tube is covered on the outer peripheral surface of the cylindrical light transmissive base body 171a, and shaped-heat-resistant resin layer 171f is formed by heating and contracting. After the light transmissive layer for shaping 171f is formed, the reverse crown-shape is formed by cutting or grinding it. As an amount of the reverse crown, it is preferable that the difference of the radius from the central portion of the light transmissive layer for shaping 171f toward the direction of the end portion is about (25-100 μm)/20 cm. On the reverse crown-shaped light transmissive layer for shaping 171f, the heat ray absorption layer 171b, heat conductive layer 171e, and releasing layer 171c are formed with the uniform thickness. When the reverse crown-shape is provided the heat ray absorption layer 171b, heat conductive layer 171e, or releasing layer 171c, it is not necessary to provide the reverse crown-shape on the light transmissive layer for shaping 171f. The light transmissive layer for shaping 171f is coated with the thickness larger than the cutting margin to the surface layer of the light transmissive base body 171a, and the thickness after cutting or grinding is 50-1000 μm, and preferably 100-500 μm at the central portion. Incidentally, the wavelength of heat ray which can passes through the light transmissive layer for shaping 171f is 0.1-20 μm, preferably, 0.3-3 μm, and adjustment agents for hardness or thermal conductivity are added as a filler, however, the light transmissive layer for shaping 171f may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, the average particle size of which is not more than 1 μm, preferably 0.1 μm, and which are transmissive for heat rays (mainly, infrared rays or far infrared rays), are dispersed in a resin binder. In order to prevent light from scattering, and to make the heat ray reach the heat ray absorption layer 171b, it is preferable that the average particle size, including the primary and secondary particles, is not more than 0.1-1 μm.

By the reverse crown provided on the light transmissive layer for shaping formed on the outside of the light transmissive base body, the transfer material is conveyed such that the transfer material is expanded from the center toward both ends, thereby, generation of wrinkles of the transfer material is prevented when the toner image is fixed by the rotation member for heat ray fixing.

As the heat lay absorption layer 171b, a heat ray absorption member in which powders of carbon black, graphite, iron black (Fe₃O₄), or each kind of ferrite and its compounds, capper oxide, cobalt oxide, red oxide (Fe₂O₃), etc., are mixed into a resin binder, is used, and 10-200 μm thick, preferably, 20-100 μm thick heat ray absorption member, whose thickness is that of the central portion after formation of the reverse crown-shape, which will be described later, is printed or coated on the outside (outer peripheral surface) of the light transmissive layer for shaping 171f, so that about 100% of heat rays, that is, 90-100%, preferably, 95-100% of heat rays, which are emitted from the heat ray irradiation member 171g, and which pass through the light transmissive material 171a and light transmissive layer for shaping 171f, are absorbed in the heat ray absorption layer 171b, and the heat ray fixing rotation member by which instantaneous heating can be carried out, is formed. After the heat ray absorption layer 171b is formed, the reverse crown-shape is formed by cutting or grinding it. As an amount of the reverse crown, it is preferable that the difference of the radius from the central portion of the heat ray absorption layer 171f toward the direction of the end portion is about (25-100 μm)/20 cm. The light transmissive layer for shaping 171f, heat conductive layer 171e, or releasing layer 171c other than the heat ray absorption layer 171b with the reverse crown shape, is formed with uniform thickness. When the reverse crown shape is formed on the other light transmissive layer for shaping 171f, heat conductive layer 171e, or releasing layer 171c, it is not necessary to form the reverse crown shape on the heat ray absorption layer 171b. When heat ray absorption rate in the heat ray absorption layer 171b is lower than about 90%, for example, about 20-80%, heat rays leak, and in the case where the first heat ray fixing roller 17a, which is the fixing roller member for heat ray fixing, is used for the monochromatic image formation, when black toner adheres to the surface of the specific position of the first heat ray fixing roller 17a due to filming, heat is generated from the toner adhered portion due to leaking heat rays, and heat is further generated by the heat ray absorption at that portion, resulting in damage of the heat ray absorption layer 171b. Further, when the first heat ray fixing roller 17a is used for the color image formation, because absorption efficiency of color toner is generally low, and further, there is difference of absorption efficiency among color toners, fixing failure or uneven fixing occurs. Accordingly, the heat ray absorption rate of the heat ray absorption layer 171b is made 90-100% which corresponds to about 100%, and more preferably 95-100%, so that the heat rays emitted from the hear ray irradiation member 171g, and which pass through the light transmissive base body 171a and the light transmissive layer for shaping 171f, are perfectly absorbed in the first heat ray fixing roller 17a. Further, when the thickness of the heat ray absorption layer 171b is not larger than 10 μm, and thin, heating speed due to absorption of heat rays in the heat ray absorption layer 171b is high, however, local heating due to the thin film causes damage or insufficient strength of the heat ray absorption layer 171b, and when the thickness of the heat ray absorption layer 171b exceeds 200 μm, and too thick, insufficient heat conduction occurs, and thermal capacity becomes large and instantaneous heating is hardly carried out. When the heat ray absorption rate of the heat ray absorption layer 171b is made 90-100% which corresponds to about 100%, and more preferably 95-100%, and the thickness of the heat ray absorption layer 171b is made 10-200 μm thick, preferably, 20-100 μm, local heat generation in the heat ray absorption layer 171b is prevented and uniform heat generation can be attained. Incidentally, the wavelength of heat ray which are emitted to the heat ray absorption layer 171b is 0.1-20 μm, preferably, 0.3-3 μm, and adjustment agents for hardness or thermal conductivity are added as a filler, however, the heat ray absorption layer 171b may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, including the primary and secondary particles, the average particle size of which is not more than 1 μm, preferably 0.1 μm, and which are transmissive for heat rays (mainly, infrared ray or far infrared ray permeability), are dispersed in a resin binder in 5-50 weight %. As described above, the thermal capacity of the heat ray absorption layer 171b is made smaller so that temperature can quickly rise, therefore, the following problem is prevented that temperature drop occurs in the first heat ray fixing roller as the heat ray fixing rotation member, causing uneven fixing. The thickness as described above is preferable, but because the heat ray absorption layer 171b may absorb about 90-100% of heat rays which correspond to about 100% of heat rays, the degree of freedom with respect to the thickness is high.

As described above, by the reverse crown provided on the heat ray absorption layer formed outside the light transmissive base body, the transfer material is conveyed such that the transfer material is squeezed and extended from the center toward both end portions, thereby, generation of wrinkles of the transfer material is prevented at toner image fixing by the rotation member for heat ray fixing.

The heat conductive layer is formed as follows: the thickness of layer (thickness) of the central portion after the reverse crown shape, which will be described later, is formed is 10-1000 μm, preferably, 50-500 μm; the binder type material in which metallic fine particles such as titan, alumina, zinc, magnesium, chrome, nickel, tantalum, molybdenum, etc., which have good heat conductivity, are dispersed in the binder, is used on the surface of the heat ray absorption layer 171b, or the solid type material in which metals such as chrome, nickel, tantalum, molybdenum, etc., which have good heat conductivity, are formed into a layer by plating, spattering, or evaporating, is used on the surface of the heat ray absorption layer 171b; and the thermal conductivity is not smaller than 50×10⁻³ J/cm·s·K, preferably, 100×10⁻³ J/cm·s·K. After the heat conductive layer 171e is formed, the reverse crown-shape is formed by cutting or grinding it. As an amount of the reverse crown, it is preferable that the difference of the radius from the central portion of the heat conductive layer 171e toward the direction of the end portion is about (25-100 μm)/20 cm. The light transmissive layer for shaping 171f, the heat ray absorption layer 171b, and releasing layer 171c other than the reverse crown-shaped heat conductive layer 171e, are formed with the uniform thickness. When the reverse crown-shape is provided on the light transmissive layer for shaping 171f, the heat ray absorption layer 171b, or the releasing layer 171c, it is not necessary to provide the reverse crown-shape on the heat conductive layer 171e. When the thickness of the heat conductive layer 171e is not larger than 10 μm, the layer thickness is too thin and the thermal capacity is insufficient, and the heat from the heat ray absorption layer 171b can not be transmitted sufficiently, and the heat in the lateral direction can not be uniform. When the thickness is over 1000 μm and too thick, the thermal capacity becomes too large, and worming-up takes a long period of time, thereby, instantaneous heating becomes difficult. When the heat conductive layer is provided, the heat is directly transmitted from the heat ray absorption layer to the heat conductive layer, and by heat conduction in the lateral direction in the heat conductive layer, the uniformity of the temperature distribution in the longitudinal direction of the heat ray absorption layer ((lateral direction), the direction in parallel to the central axis of the cylindrical light transmissive base body) can be attained. When the layer thickness of the heat conductive layer is thick, better heat transmission in the lateral direction in the heat conductive layer is obtained, and specifically when the layer thickness at end portions is thick, better heat correspondence to the end portions of the width of the transfer material is obtained.

As described above, by the reverse crown provided on the heat conductive layer formed outside the light transmissive base body, the transfer material is conveyed such that the transfer material is squeezed and extended from the center toward both end portions, thereby, generation of wrinkles of the transfer material is prevented at toner image fixing by the rotation member for heat ray fixing.

Further, being separated from the heat conductive layer 171e, the releasing layer 171c is provided in which 30-100 μm thick PFA (fluorine resin) tube, whose thickness is the thickness of the central portion after formation of the reverse crown-shape, which will be described below, is covered on the outside (outer peripheral surface) of the heat conductive layer 171e, or fluorine resin (PFA or PTFE) coating is coated thereon with 20-30 μm thickness, so that good releasability from toner is obtained. After the releasing layer 171c is formed, the reverse crown-shape is formed by cutting or grinding it. Particularly, formation of the reverse crown-shape on the releasing layer 171c is the final process, and accordingly, processing accuracy is easily increased. As an amount of the reverse crown, it is preferable that the difference of the radius from the central portion of the releasing layer 171c toward the direction of the end portion is about (25-100 μm)/20 cm. The light transmissive layer for shaping 171f, the heat ray absorption layer 171b, or heat conductive layer 171e provided lower the reverse crown-shaped releasing layer 171c, are formed with the uniform thickness. When the reverse crown-shape is provided on the light transmissive layer for shaping 171f, the heat ray absorption layer 171b, or the heat conductive layer 171e, it is not necessary to provide the reverse crown-shape on the releasing layer 171c. The releasing layer 171c and the heat conductive layer 171e are integrated and a combined-use layer (not shown) may be provided, and the reverse crown may be provided on the combined-use layer. In this case, as an amount of the reverse crown, it is preferable that the difference of the radius from the central portion of the combined-use layer toward the direction of the end portion is about (25-100 μm)/20 cm.

As described above, by the reverse crown provided on the releasing layer (or combined-use layer) formed outside the light transmissive base body, the transfer material is conveyed such that the transfer material is squeezed and extended from the center toward both end portions, thereby, generation of wrinkles of the transfer material is prevented at toner image fixing by the rotation member for heat ray fixing.

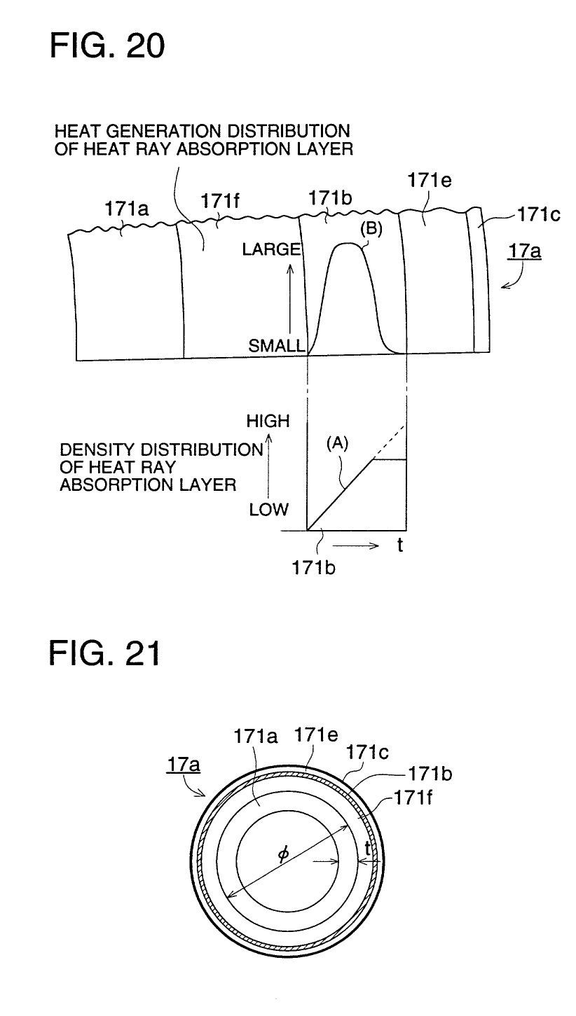

According to FIG. 20, it is preferable that heat is generated inside the heat ray absorption layer 171b by providing the density distribution of the heat ray absorption member in the heat ray absorption layer 171b of the first heat ray fixing roller 17a serving as the roller-like heat ray fixing rotation member, described in FIG. 19. The density distribution of the heat ray absorption member 171b is provided as shown by graph (A): the interface on the inscribed light transmissive base body for shaping 171f is made low density which is gradually ascending toward the outer periphery side with inclination, and the density is saturated by absorbing 100% of heat rays at a position before the outer periphery side (at the position of about ⅔-⅘ from the light transmissive base body for shaping 171a side with respect to the thickness t of the heat ray absorption layer 171b). According to that, as shown by graph (B), the distribution of heat generation by the absorption of heat ray in the heat ray absorption layer 171b is formed into a parabola which has the maximum value in the vicinity o the central portion of the heat ray absorption layer 171b, and has the minimum value in the vicinity of the interface or the outer peripheral surface. Thereby, the heat generation due to the heat ray absorption at the interface is decreased, and damage of the adhesive layer or breakage of the heat ray absorption layer 171b at the interface is prevented. Further, the density distribution from a position before the outer peripheral surface side(at the position of about ⅔-⅘ from the light transmissive layer for shaping 171f side with respect to the thickness t of the heat ray absorption layer) to the outer peripheral surface is made possible to be saturated, so that even if the outer peripheral surface layer is cut off, there is no influence. In this connection, as shown by a dotted line, a saturation layer may be formed. In conclusion, when heat rays are sufficiently absorbed at the inside, there is no influence of the density at the outside. There also be no influence of cutting. Further, the inclination is provided in the density distribution, and the distribution of the heat generation can be adjusted by changing the inclination angle.

Further, as shown in FIG. 21, the outer diameter φ of the cylindrical light transmissive base body 171a of the fist heat ray fixing roller 17a as the roller-like heat ray fixing rotation member, a 15-60 mm base body is used, and as the thickness t thereof, the larger thickness is better for the strength, and the smaller thickness is better for the thermal capacity, and from the relationship between the strength and the thermal capacity, the relationship between the outer diameter φ of the cylindrical light transmissive base body 171a and the thick ness t thereof is expressed by the following relationship:

0.05≦t/φ≦0.20

and preferably,

0.07≦t/φ≦0.14

When the outer diameter φ of the light transmissive base body 171a is 40 mm, the thickness t of the light transmissive base body 171a is 2 mm≦t≦8 mm , preferably, 2.8 mm≦t≦5.6 mm is used. When t/φ of the light transmissive base body 171a is not larger than 0.05, the strength is insufficient, and when t/φ exceeds 0.20, the thermal capacity becomes large, and heating of the first heat ray fixing roller 17a takes a long period of time. There is such a case that even the light transmissive base body absorbs about 1-20% heat rays depending on its material, and the thinner thickness is preferable within the range in which the strength can be maintained.

According to the above description, when the first heat ray fixing roller 17a as the heat ray fixing rotation member described in FIGS. 18 and 19 is used, the heat ray fixing rotation member with the reverse crown and highly accurate outer diameter, is obtained, and such a heat ray fixing rotation member using heat rays for quick start fixing can be obtained that deformation at the fixing section (nip portion) hardly occurs, fixing wrinkles do not occur, and instantaneous heating is possible or heating time period is short. Specifically, when this member is used for the image forming apparatus described in FIG. 1, quick start instantaneous heating for fixing of toner images can be carried out at the image formation, and further energy saving effect can be obtained.

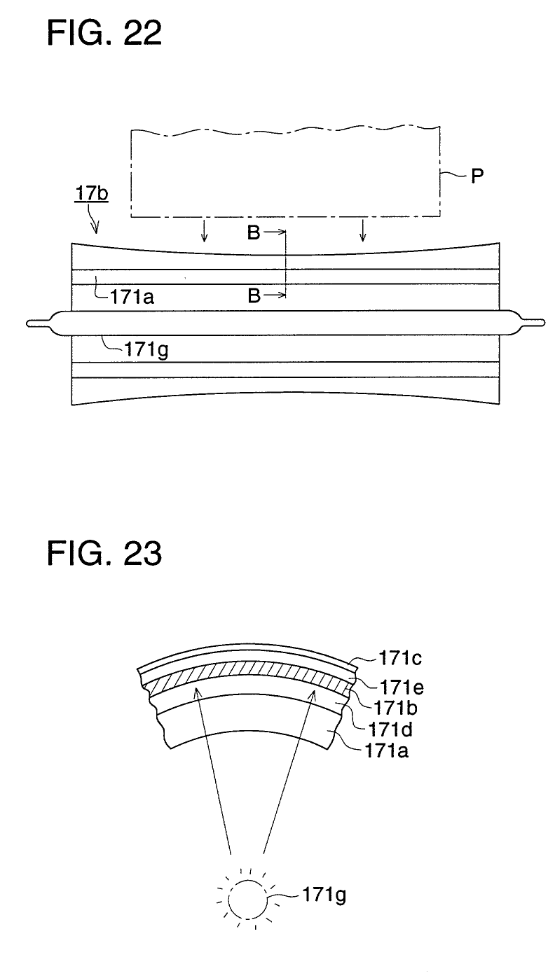

Referring to FIGS. 22, 23 and 25, another example of the heat ray fixing rotation member will be described below. FIG. 22 is a view showing the shape of the second example of the heat ray fixing rotation member, FIG. 23 is an enlarged structural sectional view, viewed from line B-B of the second example of the heat ray fixing rotation member shown in FIG. 22, and FIG. 25 is an structural sectional view of the fixing rotation member provided in opposite to the heat ray fixing rotation member of the second example shown in FIG. 22.

In the second example of the heat ray fixing rotation member, in the fixing apparatus 17 described in FIG. 1, the second heat ray fixing roller 17b is used as the heat ray fixing rotation member instead of the first heat ray fixing roller 17a, and the second fixing roller 47b is sued instead of the first fixing roller 47a. In the second example of the heat ray fixing rotation member, the fixing apparatus 17 is composed of the second heat ray fixing roller 17b which is the upper side (obverse side) roller-like heat ray fixing rotation member to fix the toner image of the obverse side image (upper surface side image), and the second fixing roller 47b which is the lower side (reverse side) roller-like fixing rotation member to fix the toner image of the reverse side image (lower surface side image). The recording sheet P is nipped at the nip portion T formed between the second heat ray fixing roller 17b and second fixing roller 47b, and the toner image on the recording sheet P is fixed by being applied with heat and pressure. As shown in FIG. 22, by the reverse crown-shape formed on each member layer provided on the outside (outer peripheral surface) of the light transmissive base body 171a, which will be described later, the second heat ray fixing roller 17b as the heat ray fixing rotation member is formed into the reverse crown-shape. By the reverse crown provided on the second heat ray fixing roller 17b as the heat ray fixing rotation member, the recording sheet P to be fixed is conveyed such that the recording sheet P is squeezed and expanded from the center toward both ends, and generation of wrinkles of the transfer material is prevented at the time of toner image fixing.

The second heat ray fixing roller 17b used as the heat ray fixing rotation member is structured, as shown by the cross section in FIG. 23, as a soft roller which is composed of a cylindrical heat transmissive base body 171a, and on the outside (outer peripheral surface) of which an elastic layer 171d, a heat ray absorption layer 171b, a heat conductive layer 171e, and a releasing layer 171c are provided in that order. The second heat ray fixing roller 17b as the heat ray fixing rotation member with the reverse crown-shape is formed by providing the reverse crown-shape on any of the elastic layer 171d, the heat ray absorption layer 171b, the heat conductive layer 171e, or the releasing layer 171c, which are provided on the outside (outer peripheral surface) of the light transmissive base body 171a. The heat ray irradiation member 171g serving as the heat ray irradiation means using, for example, the halogen lamp or xenon lamp, which mainly emits infrared rays or far infrared rays, is arranged inside the light transmissive base body 171a. Heat rays emitted from the heat ray irradiation member 17g are absorbed by the heat ray absorption layer 171b and a heat ray fixing rotation member by which instantaneous heating can be carried out, is formed (the second example of the heat ray fixing rotation member for instantaneous heating).

Further, the second fixing roller 47b used as the roller-like fixing rotation member to fix the toner image of the reverse side image, is structured as a hard roller which is, as shown by a cross section in FIG. 25, composed of a cylindrical metallic pipe 472a using, for example, aluminum material, steel material, etc., on the outer peripheral surface of which Teflon coating is printed or coated. A halogen heater 471c is arranged inside the metallic pipe 472a.

According to FIG. 23, as the cylindrical light transmissive base body 171a constituting the second heat ray fixing roller 17b, which is almost the same as the light transmissive base body in the above-described first example, Pyrex glass, ceramic material such as sapphire (Al₂o₃), CaF₂, (the thermal conductivity is (5.5-19.0)×10⁻³ J/cm·s·k) or light transmissive resins using polyimide, polyamide, (the thermal conductivity is (2.5-3.4)×10⁻³ J/cm·s·k), through which heat rays such as infrared rays or far infrared rays from the heat ray irradiation member 171g pass, are used. Incidentally, the wavelength of heat ray which can passes through the light transmissive base body 171a is 0.1-20 μm, preferably, 0.3-3 μm, and adjustment agents for hardness or thermal conductivity are added as a filler, however, the light transmissive base body 171a may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, not more than 1 μm, preferably 0.1 μm, and which are transmissive for heat rays (mainly, infrared rays or far infrared rays), are dispersed in a resin binder. In order to prevent light from scattering, and to make the heat ray reach the heat ray absorption layer 171b, it is preferable that the average particle size in the layer, including the primary and secondary particles, is not more than 1 μm, preferably, not more than 0.1 μm. Accordingly, the thermal conductivity of the light transmissive base body 171a is not so good.

The elastic layer 171d is formed of the heat ray transmissive rubber layer (base layer), in which, for example, silicon rubber whose layer thickness (thickness)at the central portion after cutting or grinding is 2-20 mm, preferably 5-15 mm, which will be described later, is used, and through which the heat rays (mainly, infrared rays or far infrared rays) can pass. It is easy and preferable that the elastic layer is shaped using the die. After the elastic layer 171d is formed, the reverse crown-shape is formed by cutting or grinding it. As an amount of the reverse crown, it is preferable that the difference of the radius from the central portion of the elastic layer 171d toward the direction of the end portion is about (25-100 μm)/20 cm. On the reverse crown-shaped elastic layer 171d, the heat ray absorption layer 171b, heat conductive layer 171e, and releasing layer 171c are formed with the uniform thickness. When the reverse crown-shape is provided the heat ray absorption layer 171b, heat conductive layer 171e, or releasing layer 171c, in the upper layer, it is not necessary to provide the reverse crown-shape on the elastic layer 171d. As the elastic layer 171d, in order to correspond to the high speed processing, such a method is adopted that powders of metallic oxides such as silica, alumina, magnesium oxide, etc., are blended in the base rubber (silicon rubber) as a filler, and the thermal conductivity is improved, and a rubber layer having the thermal conductivity not less than 8.4×10⁻¹ W/(m° C.)is preferable. When the thermal conductivity is increased, generally, hardness of rubber tends to increase, and for example, the hardness of normally 40 Hs is increased near to 60 Hs (JIS, A rubber hardness). This base layer covers most part of the elastic layer 171d of the heat ray fixing rotation member, and the amount of compression at the time of application of pressure is determined by the rubber hardness of the base layer. The intermediate layer of the elastic layer 171d is coated by fluorine rubber to 20-300 μm thickness as the oil resistance layer to prevent the oil from swelling. As the silicon rubber of the top layer of the elastic layer 171d, RTV (Room Temperature Vulcanizing) or LTV (Low Temperature Vulcanizing), which has better releasability than HTV (High Temperature Vulcanizing), is coated with the same thickness as that of the intermediate layer. Incidentally, the wavelength of heat ray which can passes through the elastic layer 171d is 0.1-20 μm, preferably, 0.3-3 μm, and the elastic layer 171d may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, the average particle size of which, including the primary and secondary particles, is not more than 1 μm, preferably 0.1 μm, and which are transmissive for heat rays (mainly, infrared rays or far infrared rays), are dispersed in a resin binder, as adjustment agents for hardness or thermal conductivity. In order to prevent light from scattering, and to make the heat ray reach the heat lay absorption layer 171b, it is preferable that the average particle size, including the primary and secondary particles, is not more than 1 μm, preferably, 0.1 μm.

By the reverse crown provided on the light transmissive layer for shaping formed on the outside of the light transmissive base body, the transfer material is conveyed such that the transfer material is squeezed and expanded from the center toward both ends, thereby, generation of wrinkles of the transfer material is prevented when the toner image is fixed by the heat ray fixing rotation member.

As the heat lay absorption layer 171b, a heat ray absorption member in which powders of carbon black, graphite, iron black (Fe₃O₄), or each kind of ferrite and its compounds, capper oxide, cobalt oxide, red oxide (Fe₂O₃), etc., are mixed into a resin binder, is used, and 10-200 μm thick, preferably, 20-100 μm thick heat ray absorption member, whose thickness is that of the central portion after formation of the reverse crown-shape, which will be described later, is formed by being printed or coated on the outside (outer peripheral surface) of the light transmissive base body 171a, so that about 100% of heat rays, that is, 90-100%, preferably, 95-100% of heat rays, which are emitted from the heat ray irradiation member 171g, and which pass through the light transmissive material 171a and elastic layer 171d, are absorbed in the heat ray absorption layer 171b, and the heat ray fixing rotation member by which instantaneous heating can be carried out, is formed. After the heat ray absorption layer 171b is formed, the reverse crown-shape is formed by cutting or grinding it. As an amount of the reverse crown, it is preferable that the difference of the radius from the central portion of the heat ray absorption layer 171b toward the direction of the end portion is about (25-100 μm)/20 cm. The elastic layer 171d, heat conductive layer 171e, or releasing layer 171c other than the heat ray absorption layer 171b with the reverse crown shape, is formed with uniform thickness. When the reverse crown shape is formed on the other elastic layer 171d, heat conductive layer 171e, or releasing layer 171c, it is not necessary to form the reverse crown shape on the heat ray absorption layer 171b. When heat ray absorption rate in the heat ray absorption layer 171b is lower than about 90%, for example, about 20-80%, heat rays leak, and in the case where the second heat ray fixing roller 17b, which is the fixing rotation member for heat ray fixing, is used for the monochromatic image formation, when black toner adheres to the surface of the specific position of the second heat ray fixing roller 17b due to filming, heat is generated from the toner adhered portion due to leaking heat rays, and heat is further generated by the heat ray absorption at that portion, resulting in damage of the heat ray absorption layer 171b. Further, when the second heat ray fixing roller 17b is used for the color image formation, because absorption efficiency of color toner is generally low, and further, there is difference of absorption efficiency among color toners, fixing failure or uneven fixing occurs. Accordingly, the heat ray absorption rate of the heat ray absorption layer 171b is made 90-100% which corresponds to about 100%, and more preferably 95-100%, so that the heat rays emitted from the hear ray irradiation member 171g, and which pass through the light transmissive base body 171a and the elastic layer 171d, are perfectly absorbed in the second heat ray fixing roller 17b. Further, when the thickness of the heat ray absorption layer 171b is not larger than 10 μm, and thin, heating speed due to absorption of heat rays in the heat ray absorption layer 171b is high, however, local heating due to the thin film causes damage or insufficient strength of the heat ray absorption layer 171b, and when the thickness of the heat ray absorption layer 171b exceeds 200 μm, and too thick, insufficient heat conduction occurs, and thermal capacity becomes large and instantaneous heating is hardly carried out. When the heat ray absorption rate of the heat ray absorption layer 171b is made 90-100% which corresponds to about 100%, and more preferably 95-100%, and the thickness of the heat ray absorption layer 171b is made 10-200 μm thick, preferably, 20-100 μm, local heat generation in the heat ray absorption layer 171b is prevented and uniform heat generation can be attained. Incidentally, the wavelength of heat ray which are emitted to the heat ray absorption layer 171b is 0.1-20 μm, preferably, 0.3-3 μm, and adjustment agents for hardness or thermal conductivity are added as a filler, however, the heat ray absorption layer 171b may be formed of materials, in which fine particles of a metallic oxide such as titan oxide, aluminum oxide, zinc oxide, silicon oxide, magnesium oxide, calcium carbonate, etc., a particle size of which is not more than ½, preferably ⅕ of the wavelength of a heat ray, that is, including the primary and secondary particles, the average particle size of which is not more than 1 μm, preferably 0.1 μm, and which are transmissive for heat rays (mainly, infrared ray or far infrared ray permeability), are dispersed in a resin binder in 5-50 weight %. As described above, the thermal capacity of the heat ray absorption layer 171b is made smaller so that temperature can quickly rise, therefore, the following problem is prevented that temperature drop occurs in the second heat ray fixing roller 17b as the heat ray fixing rotation member, causing uneven fixing. The thickness as described above is preferable, but because the heat ray absorption layer 171b may absorb about 90-100% of heat rays which correspond to about 100% of heat rays, the degree of freedom with respect to the thickness is high.

As described above, by the reverse crown provided on the heat ray absorption layer formed outside the light transmissive base body, the transfer material is conveyed such that the transfer material is squeezed and extended from the center toward both end portions, thereby, generation of wrinkles of the transfer material is prevented at toner image fixing by the rotation member for heat ray fixing.

The heat conductive layer 171e, which is almost the same as the heat conductive layer of the above-described first example, is formed as follows: the thickness of layer (thickness) of the central portion after the reverse crown shape, which will be described later, is formed is 10-1000 μm, preferably, 50-500 μm; the binder type material in which metallic fine particles such as titan, alumina, zinc, magnesium, chrome, nickel, tantalum, molybdenum, etc., which have good heat conductivity, are dispersed in the binder, is used on the surface of the heat ray absorption layer 171b, or the solid type material in which metals such as chrome, nickel, tantalum, molybdenum, etc., which have good heat conductivity, are formed into a layer by plating, spattering, or vacuum-evaporating, is used on the surface of the heat ray absorption layer 171b; and the thermal conductivity is not smaller than 50×10⁻³ J/cm·s·K, preferably, 100×10⁻³ J/cm·s·K. After the heat conductive layer 171e is formed, the reverse crown-shape is formed by cutting or grinding it. As an amount of the reverse crown, it is preferable that the difference of the radius from the central portion of the heat conductive layer 171e toward the direction of the end portion is about (25-100 μm)/20 cm. The elastic layer 171d, the heat ray absorption layer 171b, and releasing layer 171c other than the reverse crown-shaped heat conductive layer 171e, are formed with the uniform thickness. When the reverse crown-shape is provided on the elastic layer 171d, the heat ray absorption layer 171b, or the releasing layer 171c, it is not necessary to provide the reverse crown-shape on the heat conductive layer 171e. When the thickness of the heat conductive layer 171e is not larger than 10 μm, the layer thickness is too thin and the thermal capacity is insufficient, and the heat from the heat ray absorption layer 171b can not be transmitted sufficiently to the lateral direction, and the heat in the lateral direction can not be uniform. When the thickness is over 1000 μm and too thick, the thermal capacity becomes too large, and worming-up takes a long period of time, thereby, instantaneous heating becomes difficult. When the heat conductive layer is provided, the heat is directly transmitted from the heat ray absorption layer to the heat conductive layer, and by heat conduction in the lateral direction in the heat conductive layer, the uniformity of the temperature distribution in the longitudinal direction of the heat ray absorption layer ((lateral direction), the direction in parallel to the central axis of the cylindrical light transmissive base body) can be attained. When the layer thickness of the heat conductive layer is thick, better heat transmission in the lateral direction in the heat conductive layer is obtained, and specifically when the layer thickness at end portions is thick, better heat correspondence to the end portions of the width of the transfer material is obtained.

As described above, by the reverse crown provided on the heat conductive layer formed outside the light transmissive base body, the transfer material is conveyed such that the transfer material is squeezed and extended from the center toward both end portions, thereby, generation of wrinkles of the transfer material is prevented at toner image fixing by the rotation member for heat ray fixing.

Further, the releasing layer 171c having the same structure as the releasing layer of the above-described first example, is provided. Being separated from the heat conductive layer 171e, the releasing layer 171c is provided in which 30-100 μm thick PFA (fluorine resin) tube, whose thickness is the thickness of the central portion after formation of the reverse crown-shape, which will be described below, is covered on the outside (outer peripheral surface) of the heat conductive layer 171e, or fluorine resin (PFA or PTFE) coating is coated thereon with 20-30 μm thickness, so that good releasability from toner is obtained. After the releasing layer 171c is formed, the reverse crown-shape is formed by cutting or grinding it. As an amount of the reverse crown, it is preferable that the difference of the radius from the central portion of the releasing layer 171c toward the direction of the end portion is about (25-100 μm)/20 cm. Particularly, formation of the reverse crown-shape on the releasing layer 171c is the final process, and accordingly, processing accuracy is easily increased. The elastic layer 171d, the heat ray absorption layer 171b, or heat conductive layer 171e provided lower the reverse crown-shaped releasing layer 171c, are formed with the uniform thickness. When the reverse crown-shape is provided on the elastic layer 171d, the heat ray absorption layer 171b, or the heat conductive layer 171e in the lower layer, it is not necessary to provide the reverse crown-shape on the releasing layer 171c. The releasing layer 171c and the heat conductive layer 171e are integrated and a combined-use layer (not shown) may be provided, and the reverse crown may be provided on the combined-use layer. In this case, as an amount of the reverse crown, it is preferable that the difference of the radius from the central portion of the combined-use layer toward the direction of the end portion is about (25-100 μm)/20 cm.

As described above, by the reverse crown provided on the releasing layer (or combined-use layer) formed outside the light transmissive base body, the transfer material is conveyed such that the transfer material is squeezed and extended from the center toward both end portions, thereby, generation of wrinkles of the transfer material is prevented at toner image fixing by the rotation member for heat ray fixing.

In the above-described heat ray fixing rotation member having the elastic layer, the reverse crown is provided on the elastic layer or its outer layer, however, the light transmissive layer for shaping is formed on the outside of the light transmissive base body and the inside of the heat ray absorption layer, for example, in the inside of the elastic layer in the same manner as described above, and the reverse crown-shape may be provided on the light transmissive layer for shaping.

In also the second heat ray fixing roller 17b serving as the heat ray fixing rotation member, it is preferable that heat is generated inside the heat ray absorption layer 171b by providing the density distribution of the heat ray absorption member, described in FIG. 5, in the heat ray absorption layer 171b of the second heat ray fixing roller 17b. Further, in the same manner as described in FIG. 6, as the outer diameter φ of the cylindrical light transmissive base body 171a of the second heat ray fixing roller 17b as the roller-like heat ray fixing rotation member, a 15-60 mm base body is used, and as the thickness t thereof, the larger thickness is better for the strength, and the smaller thickness is better for the thermal capacity, and from the relationship between the strength and the thermal capacity, the relationship between the outer diameter φ of the cylindrical light transmissive base body 171a and the thickness t thereof is expressed by the following relationship:

0.05≦t/φ≦0.20

and preferably,

0.07≦t/φ≦0.14

When the outer diameter φ of the light transmissive base body 171a is 40 mm, as the thickness t of the light transmissive base body 171a, 2 mm≦t≦8 mm , preferably, 2.8 mm≦t≦5.6 mm is used. When t/φ of the light transmissive base body 171a is not larger than 0.05, the strength is insufficient, and when t/φ exceeds 0.20, the thermal capacity becomes large, and heating of the second heat ray fixing roller 17a takes a long period of time. There is such a case that even the light transmissive base body absorbs about 1-20% heat rays depending on its material, and the thinner thickness is preferable within the range in which the strength can be maintained.

According to the above description, when the second heat ray fixing roller 17a as the heat ray fixing rotation member described in FIGS. 22 and 23 is used, the heat ray fixing rotation member with the reverse crown and highly accurate outer diameter, is obtained, and such a heat ray fixing rotation member using heat rays for quick start fixing can be obtained that deformation at the fixing section (nip portion) hardly occurs, fixing wrinkles do not occur, and instantaneous heating is possible or heating time period is short. Specifically, when this member is used for the image forming apparatus described in FIG. 1, quick start instantaneous heating for fixing of toner images can be carried out at the image formation, and further energy saving effect can be obtained.

According to the present invention, the following effects can be obtained.

By obtaining a light transmissive base body with high accurate diameter, a fixing roller member using heat rays for quick start fixing by which instantaneous heating is enabled or a heating time period is shortened is provided.

By obtaining a light transmissive base body with high accurate diameter, a fixing roller member using heat rays for quick start fixing by which uneven fixing or fixing wrinkles are prevented, instantaneous heating is enabled or a heating time period is shortened is provided.

By a reverse crown provided on a light transmissive layer for shaping formed outside a light transmissive base body, generation of wrinkles of the transfer material at toner image fixing by heat ray fixing rotation member is prevented.

By a reverse crown provided on a heat ray absorption layer formed outside a light transmissive base body, generation of wrinkles of the transfer material at toner image fixing by heat ray fixing rotation member is prevented.

By a reverse crown provided on a heat conductive layer formed outside a light transmissive base body, generation of wrinkles of the transfer material at toner image fixing by heat ray fixing rotation member is prevented.

By a reverse crown provided on a releasing layer formed outside a light transmissive base body, generation of wrinkles of the transfer material at toner image fixing by heat ray fixing rotation member is prevented.

By a reverse crown provided on an elastic layer in the heat ray fixing rotation member having the elastic layer and heat ray absorption layer in that order outside the light transmissive base body, generation of wrinkles of the transfer material at toner image fixing by heat ray fixing rotation member is prevented.

By a reverse crown provided on a heat ray absorption layer in the heat ray fixing rotation member having the elastic layer and heat ray absorption layer in that order outside the light transmissive base body, generation of wrinkles of the transfer material at toner image fixing by heat ray fixing rotation member is prevented.

By a reverse crown provided on a heat conductive layer formed outside the heat ray absorption layer, in the heat ray fixing rotation member having the elastic layer and heat ray absorption layer in that order outside the light transmissive base body, generation of wrinkles of the transfer material at toner image fixing by heat ray fixing rotation member is prevented.

By a reverse crown provided on a releasing layer formed outside the heat ray absorption layer, in the heat ray fixing rotation member having the elastic layer and heat ray absorption layer in that order outside the light transmissive base body, generation of wrinkles of the transfer material at toner image fixing by heat ray fixing rotation member is prevented.

By a reverse crown provided on a light transmissive layer for shaping formed outside the light transmissive base body, in the heat ray fixing rotation member having the elastic layer and heat ray absorption layer in that order outside the light transmissive base body, generation of wrinkles of the transfer material at toner image fixing by heat ray fixing rotation member is prevented.

What is claimed is:

1. A fixing apparatus for fixing a toner image on a transfer medium by applying heat and pressure onto said transfer medium, comprising:
a heat ray irradiating device to irradiate heat rays; and
a pair of fixing rollers, being hollow cylinders, wherein at least one of said fixing rollers comprises
a base body being a hollow cylinder and capable of transmitting said heat rays irradiated from said heat ray irradiating device,
a heat-resistant resin layer formed on an outer surface of said base body and being capable of transmitting said heat rays irradiated from said heat ray irradiating device, and
a heat ray absorptive layer provided on said heat-resistant resin layer.

2. The fixing apparatus of claim 1,
wherein an outer surface of said heat-resistant resin layer is shaped by a shaping process after it is formed on the outer surface of said base body.

3. The fixing apparatus of claim 2,
wherein said heat ray absorptive layer is provided onto said outer surface of said heat-resistant resin layer shaped by said shaping process.

4. The fixing apparatus of claim 2,
wherein said outer surface of said heat-resistant resin layer is shaped into a reverse-crown shape with respect to a longer direction of said fixing roller.

5. The fixing apparatus of claim 1,
wherein said fixing roller further comprises a heat conductive layer provided on said heat ray absorptive layer.

6. The fixing apparatus of claim 5,
wherein an outer surface of said heat conductive layer is shaped into a reverse-crown shape with respect to a longer direction of said fixing roller.

7. The fixing apparatus of claim 1,
wherein at least one of said fixing rollers further comprises an elastic material layer being capable of transmitting said heat rays irradiated from said heat ray irradiating device and provided between said heat-resistant resin layer and said heat ray absorptive layer.

8. The fixing apparatus of claim 7,
wherein an outer surface of said heat-resistant resin layer is shaped by a shaping process after it is formed on the outer surface of said base body.

9. The fixing apparatus of claim 8,
wherein said elastic material layer is provided onto the outer surface of said heat-resistant resin layer shaped by said shaping process.

10. The fixing apparatus of claim 7,
wherein toner images formed on both surfaces of said transfer medium are fixed at a same time.

11. The fixing apparatus of claim 7,
wherein an outer surface of said elastic material layer is shaped into a reverse-crown shape with respect to a longer direction of said fixing roller.

12. A fixing roller for fixing a toner image on a transfer medium by applying heat and pressure onto said transfer medium, comprising:
a base body being a hollow cylinder and capable of transmitting heat rays;
a heat-resistant resin layer formed on the outer surface of said base body and being capable of transmitting said heat rays; and
a heat ray absorptive layer provided on said heat-resistant resin layer.

13. The fixing roller of claim 12,
wherein an outer surface of said heat-resistant resin layer is shaped by a shaping process after it is formed on the outer surface of said base body.

14. The fixing roller of claim 13,
wherein said heat ray absorptive layer is provided onto said outer surface of said heat-resistant resin layer shaped by said shaping process.

15. The fixing roller of claim 12,
wherein said fixing roller further comprises an elastic material layer being capable of transmitting said heat rays and provided between said heat-resistant resin layer and said heat ray absorptive layer.

16. The fixing of claim 15,
wherein an outer surface of said heat-resistant resin layer is shaped by a shaping process after it is formed on the outer surface of said base body.

17. The fixing roller of claim 16,
wherein said elastic material layer is provided onto said outer surface of said heat-resistant resin layer shaped by said shaping process.

18. An image forming apparatus, comprising:
toner image forming means for forming a toner image on a transfer medium; and
conveyance means for conveying said transfer medium, on which said toner image is formed, to a fixing means comprised of:
a heat ray irradiating device to irradiate heat rays; and
a pair of fixing rollers, being hollow cylinders, wherein at least one of said fixing rollers comprises
a base body being a hollow cylinder and capable of transmitting said heat rays irradiated from said heat ray irradiating device,
a heat-resistant resin layer formed on an outer surface of said base body and being capable of transmitting said heat rays irradiated from said heat ray irradiating device, and
a heat ray absorptive layer provided on said heat-resistant resin layer.

19. The image forming apparatus of claim 18,
wherein an outer surface of said heat-resistant resin layer is shaped by a shaping process after it is formed on the outer surface of said base body.

20. The image forming apparatus of claim 19,
wherein said heat ray absorptive layer is provided onto said outer surface of said heat-resistant resin layer shaped by said shaping process.

21. The image forming apparatus of claim 18,
wherein at least one of said fixing rollers further comprises an elastic material layer being capable of transmitting said heat rays irradiated from said heat ray irradiating device and provided between said heat-resistant resin layer and said heat ray absorptive layer.

22. The image forming apparatus of claim 21,
wherein an outer surface of said heat-resistant resin layer is shaped by a shaping process after it is formed on the outer surface of said base body.

23. The image forming apparatus of claim 22,
wherein said elastic material layer is provided onto said outer surface of said heat-resistant resin layer shaped by said shaping process.

24. The image forming apparatus of claim 21,
wherein toner images formed on both surfaces of said transfer medium are fixed at a same time.

25. The fixing apparatus of claim 1,
wherein said heat ray absorptive layer absorbs almost 100% of heat rays irradiated from said heat ray irradiating device.
